(19) United States
(12) Patent Application Publication
(10) Pub. No.: US 2025/0062836 A1
(43) Pub. Date: Feb. 20, 2025

(54) SYSTEM AND METHOD OF CALIBRATING AND TESTING A QKD TRANSMITTER

(71) Applicant: HEQA SECURITY LTD, Modi'ni- Maccabim-Re'ut (IL)

(72) Inventors: Nitzan LIVNEH; Hagai Shmuel EISENBERG, Jerusalem (IL); Yehuda PILNYAK, Tel-Aviv (IL)

(21) Appl. No.: 18/725,923

(22) PCT Filed: Jan. 5, 2023
(86) PCT No.: PCT/IL2023/050018

§ 371 Date: Jul. 1, 2024

Related U.S. Application Data
(60) Provisional application No. 63/296,536, filed on Jan. 5, 2022.

(51) Int. Cl. H04B 10/70; H04B 10/516

(52) U.S. Cl. CPC H04B 10/70; H04B 10/516

(57) ABSTRACT

Some embodiments relate to a QKD transmitter configured to generate a plurality of pulse signals, wherein voltage polarity of at least one of the plurality of pulse signals is opposite to a voltage polarity of at least another one of said plurality of pulse signals, combine the plurality of pulse signals and generate therefrom a light-modulating signal, modulate light signals by the light-modulating signal, measure the modulated light signals and generate measurement data indicative thereof, and adjust at least one of amplitude and delay time of at least some of the plurality of pulse signals for transmission of a desired quantum communication state.

### CROSS-REFERENCE TO RELATED APPLICATIONS

This application is a national phase filing under 35 C.F.R. § 371 of and claims priority to PCT Patent Application No. PCT/IL2023/050018, filed on Jan. 5, 2023, which claims the priority benefit under 35 U.S.C. § 119 of U.S. Patent Application No. 63/296,536, filed on Jan. 5, 2022, the contents of each of which are hereby incorporated in their entireties by reference.

### TECHNOLOGICAL FIELD

The present application is generally in the field of quantum key distribution (QKD) applications, and particularly relates to the calibration and/or testing of QKD transmitters.

### BACKGROUND

This section intends to provide background information concerning the present application, which is not necessarily prior art.

In order to enable mass deployment of QKD systems and mass manufacturing (e.g., factory level automation), the QKD system must be robust enough so that on power-up the system would automatically optimize its parameters and start performing the QKD sequence. This system initialization stage needs to be done in an environment which is not as controlled and sterile as a lab environment, under a wide range of possible temperature levels, after shipping and storing in unknown conditions, and possibly after repairing and/or component changing e.g., replacement of system components, such as the transmitter and/or of the receiver units, and/or pairing to a new/unfamiliar receiver. Therefore, the conventional factory calibration of a QKD receiver-transmitter pair of units is typically insufficient and may be prone to instabilities and malfunctions after deployment and/or under unexpected working conditions.

Since QKD systems have a high signal bandwidth, often higher than 10 GHz, analyzing the signal quality without lab equipment and without a receiver becomes a challenging task. Particularly, in case of QKD systems, in order to prevent side channel attacks, the system calibration should not rely on feedbacks from any device or person located outside the transmitter (or receiver) system, as it exposes the system to attacks. Rather, it is necessary that the system initialization stages be self-contained.

Wang et al (“Integrated electronics in 130 nm CMOS process for quantum key distribution sender device”, Rev. Sci. Instrum. 91,034701 (2020)) presents an integrated electronic system in the 130 nm complementary metal oxide semiconductor process for the QKD sender device. The electronics provide driving signals for the optics at the sender terminal of the quantum channel in QKD and consist mainly of three key modules, namely, a laser diode driver with a high slew rate, a high-speed physical random number generator, and a pre-driver for the electro-optic modulator. The electronic system is designed to operate at frequencies as high as 625-MHz to accommodate the frequency of the QKD system. The high degree of integration is advantageous for miniaturizing QKD sender devices.

### General Description

The calibration/testing of QKD transmitter systems after deployment, and/or in between operations, thereof, should be carried out with minimal, or no, external intervention, to eliminate tampering and/or eavesdropping attempts. The present application provides QKD transmitter configurations capable of self-calibration/testing with minimal, or altogether without requiring, receiving feedback indications from external unit(s) e.g., from a QKD receiver or an oscilloscope. For this purpose, QKD transmitter configurations hereof are configured to generate a light-modulating signal by combining a plurality of selectively obtained and/or adjusted electric/EM pulse signals, measure optical signals generated by light modulation utilizing the light-modulating signal and generating measurement data/signals indicative thereof, and adjust one or more of the electric/EM pulse signals based on the measurement data to accordingly adjust the light modulation signal to obtain desired quantum communication states by the light modulation.

Accordingly, in embodiments hereof the QKD transmitter comprises a modulator driving portion having a plurality of electric/EM pulse signal sources, at least one of which configured to generate electric/EM pulse signals being a substantial inversion (e.g., having an opposite amplitude direction i.e., opposite voltage polarity) of electric/EM pulse signals generated by at least another one of the plurality of signal pulse sources, and a plurality of analog combiners configured to generate the light-modulating signal that is substantially proportional to a summation/superposition of the pulse signals generated by the plurality of electric/EM pulse signal sources. The light-modulating signal is used for modulating quantum communication states in coherent (e.g., laser) light, and the QKD transmitter is configured to measure the modulated quantum communication states and generate measurement data indicative thereof, and carry out from time-to-time (or periodically) self-testing/calibration procedures to adjust the electric/EM pulse signals from one or more of the electric/EM pulse signal sources based on the generated measurement data.

One or more of the electric/EM pulse signal sources can be coupled to signal manipulation means configured to controllably adjust at least one of the amplitude and time delay of the pulse signals thereby generated, before it is input to the analog combiner. A control unit is used to process the measurement data and determine based thereon a gain value and/or time delay value for one or more of the signal manipulation means for adjusting the light-modulating signal to produce the required quantum communication states. The control unit can be configured to scan for the signal manipulation means, of the one or more of the electric/EM pulse signal sources, permissible gain test values and/or time delay test values, generate control signals for producing optical signals utilizing the light-modulating signal as adjusted with the scanned test values, process respective measurement data obtained for the adjusted light-modulating signal, and determine based thereon optimal gain and/or time delay values for one or more of the signal manipulation means.

Optionally, but in some embodiments preferably, the electrical pulse signal output from at least one of the electric/EM pulse signal sources is passed through a tuneable gain unit configured to controllably adjust the amplitude of the electric/EM pulse signals generated by the electric/EM pulse signal source. Optionally, but in some embodiments preferably, the pulse signal output from at least one of the electric/EM pulse signal sources is passed through a tuneable time delay unit configured to controllably apply a time delay to the electric/EM pulse signals generated by the electric/EM pulse signal source. The output of each one of the electric/EM pulse signal sources may be coupled to a respective pair of serially coupled gain and time delay units. The present disclosure exemplifies passing the electric/EM pulse signals through a gain unit and thereafter through the time delay unit, but the order of these units may be changed for one or more of the electric/EM pulse signal sources, if so required.

In some possible embodiments the QKD transmitter comprises 3 (three) electric/EM pulse signal sources and 2 (two) analog combiners configured to generate the light modulating signal from the adjusted or non-adjusted electric/EM pulse signals. A first analog combiner can be configured to superposition/summate the adjusted (or non-adjusted) output of two of the electric/EM pulse signal sources having opposite voltage polarities. A second analog combiner can be configured to superposition/summate the output from the first analog combiner with the adjusted (or non-adjusted) output from the third electric/EM pulse signal source for producing the light modulating signal. The light modulating signal produced by the second analog combiner is passed in some embodiments through a tuneable output gain unit configured to controllably adjust the amplitude of the light-modulating signal driving the electrooptical modulator.

In other possible embodiments the QKD transmitter comprises 4 (four) electric/EM pulse signal sources and three analog combiners configured to generate the light modulating signal from the adjusted or non-adjusted electric/EM pulse signals. A first analog combiner can be configured to superposition/summate the adjusted (or non-adjusted) output of two of the electric/EM pulse signal sources having opposite voltage polarities. A second analog combiner can be configured to superposition/summate the output from the first analog combiner with the adjusted (or non-adjusted) output from a third electric/EM pulse signal source. The third analog combiner can be configured to superposition/summate the output from the second analog combiner with the adjusted (or non-adjusted) output from the fourth electric/EM pulse signal source, for producing the light modulating signal. The light modulating signal produced by the third analog combiner is passed in some embodiments through a tuneable gain unit configured to controllably adjust the amplitude of the light-modulating signal driving the electrooptical modulator.

The exact order of the superposition/summation of the electric/EM pulse signals is not critical, and it can be changed per application specific design considerations/requirements. The present disclosure provides various calibration and/or testing procedures for setting various parameters of the QKD transmitter. Since at least some of the parameter determined by the calibration and/or testing procedures depends on the particular order of the units/components of the QKD transmitter, the same order used for carrying out the calibration and/or testing procedures should be thereafter maintained.

The calibration procedures disclosed herein can be performed once e.g., during factory calibration, on installation, on power up, during software (SW), firmware (FW), and/or FPGA code update, and/or when changing the operating frequency (e.g., upon replacement of the receiver unit), or intermittently or periodically/routinely during system operation in between QKD sequences. In some embodiments the quantum communication states are used as calibration patterns during the system operation.

According to one aspect there is provided a QKD transmitter system comprising: a plurality of pulse signal sources, at least one of which configured to generate pulse signals which voltage polarity is opposite to a voltage polarity of amplitudes' of pulse signals of at least another one of the plurality of signal pulse sources; a plurality of signal manipulating units, each configured to controllably adjust at least one of amplitude and delay time of at least some of the pulse signals generated by the plurality of pulse signal sources; and a plurality of analog combiner units configured to combine the adjusted and non-adjusted pulse signals and generate therefrom a light-modulating signal for modulating quantum communication states in light generated by a light source. The light-modulating signal can be substantially proportional to a summation of the adjusted and non-adjusted pulse signals.

The QKD transmitter can comprise an output tuneable gain unit configured to controllably adjust the light-modulating signal before modulating the quantum communication states. Optionally, but in some embodiments preferably, the QKD transmitter comprises three pulse signal sources, respective three signal manipulating units, and two analog combiner units. In some embodiments the QKD transmitter is configured such that the pulse signals generated by the pulse signal source configured to generate the pulse signals with the opposite voltage polarity are not combined with pulse signals from the other pulse signal sources for generation of at least one main quantum states of the quantum communication states. The first analog combiner (Σ₁) of the two analog combiners can be configured to combine pulse signals generated by second and third pulse signal sources (P₁ and P₂) of the three pulse signal sources having the opposite voltage polarities, and a second analog combiner (Σ₀) of the two analog combiners is configured to combine signals produced by the first analog combiner (Σ₁) with pulse signals generated by a first pulse signal source (P₀) of the three pulse signal sources. Alternatively, the QKD transmitter is configured to combine the first, second and third, pulse signal sources (P₀, P₁ and P₂) by a single analog combiner.

The QKD transmitter is configured in some embodiments to cause the respective signal manipulating unit of the first pulse signal source (P₀) and the output tuneable gain unit (Gm) to adjust the amplitudes of signals thereby received such that power/intensity I of the modulated light responsive to pulse signals generated by the first pulse signal source (P₀) is attenuated by a predefined upper-level intensity setting factor α to about α·I, wherein 0.95≤α<1. The QKD transmitter can be further configured to cause the respective signal manipulating unit of the second pulse signal source (P₁) to adjust the amplitudes of signals thereby received such that power/intensity of the modulated light I responsive to pulse signals generated by the first pulse signal source (P₀) is attenuated by a predefined mid-intensity level setting factor β to about β·I, wherein β<α.

In some embodiments the QKD transmitter is configured to cause the respective signal manipulating unit of the first pulse signal source (P₀) to adjust the amplitude of signals thereby received such that power/intensity of the modulated light I responsive to pulse signals generated by the first and second pulse signal sources (P₀ and P₁) is attenuated by an upper-mid-level intensity setting factor γ to an upper-mid-level power/intensity I_{β}, wherein β<γ<α. The QKD transmitter can be configured to cause the respective signal manipulating unit of the third pulse signal source (P₂) to adjust the amplitude of signals thereby received such that power/intensity of the modulated light I responsive to pulse signals generated by the first, second and third, pulse signal sources (P₀, P₁ and P₂) is attenuated to the upper-mid-level power/intensity I_{β}.

The QKD transmitter can be configured to cause the respective signal manipulating unit of the third pulse signal source (P₂) to adjust the amplitude of signals thereby received such that power/intensity of the modulated light I responsive to pulse signals generated by the second and third pulse signal sources (P₁ and P₂) is attenuated to the about half of the upper-mid-level power/intensity I_{β}. The QKD transmitter can be configured to cause the respective signal manipulating unit of the first and/or second pulse signal sources (P₀ and/or P₁) to adjust the time delay of signals thereby received such that power/intensity of the modulated light I responsive to pulse signals generated by the first and second pulse signal sources is minimized. The QKD transmitter is configured in some embodiments to cause the respective signal manipulating unit of the third pulse signal source (P₂) to adjust the time delay of signals thereby received such that power/intensity of the modulated light I responsive to pulse signals generated by the second and third pulse signal sources is minimized.

The QKD transmitter comprises in some embodiments two pairs of the pulse signal sources, respective four signal manipulating units each coupled to one of the pulse signals sources, and three analog combiner units, wherein the pulse signal sources of each pair of the pulse signal sources are configured to generate pulse signals of opposite voltage polarities. One pair of the pulse signals sources can be configured to generate main quantum states of the quantum communication states, and the other pair of the pulse signals sources can be configured to generate decoy states of the quantum communication states.

In possible embodiments, a first analog combiner (Σ₂) of the three analog combiners is configured to combine pulse signals generated by fourth and third pulse signal sources (P₃ and P₂) forming one of the pairs of the pulse signal sources, a second analog combiner (Σ₁) of the three analog combiners can be configured to combine signals produced by the first analog combiner (Σ₂) with pulse signals generated by a second pulse signal source (P₁) of the four pulse signal sources, a third analog combiner (Σ₀) of the three analog combiners can be configured to combine signals produced by the second analog combiner (Σ₁) with pulse signals generated by a first pulse signal source (P₀) of the four pulse signal sources, the first and second pulse signal sources (P₀ and P₁) are forming the other pair of pulse signal sources. Alternatively, the QKD transmitter is configured to combine the first, second, third and fourth, pulse signal sources (P₀, P₁, P₂ and P₃) by a single analog combiner.

The QKD transmitter is configured in some embodiments to cause the respective signal manipulating unit of the first pulse signal source (P₀) and the output tuneable gain unit (Gₘ) to adjust amplitudes of signals thereby received such that power/intensity I responsive to pulse signals generated by the first pulse signal source (P₀) of the modulated light is attenuated by a predefined upper-level intensity setting factor α to an upper-level power/intensity Iₚₐₜₑᵣₙ₁=α·I, wherein 0.95≤α<1. The QKD transmitter can be configured to cause the respective signal manipulating unit of the second pulse signal source (P₁) to adjust amplitudes of signals thereby received such that power/intensity of the modulated light I responsive to pulse signals generated by the second pulse signal source (P1) is attenuated to a mid-intensity level Iₚₐₜₜₑᵣₙ₂ of about β·Iₚₐₜₜₑᵣₙ₁, wherein β<α is predefined mid-intensity level setting factor.

In possible embodiments the QKD transmitter is configured to cause the respective signal manipulating unit of the second pulse signal source (P₁) to adjust amplitudes of signals thereby received such that power/intensity of the modulated light I responsive to pulse signals generated by the first and second pulse signal sources (P₀ and P₁) is attenuated to a fine-tuned-intensity level Iₚₐₜₜₑᵣₙ₃ of about Iₚₐₜₜₑᵣₙ₂. The QKD transmitter can be configured to cause the respective signal manipulating unit of the third pulse signal source (P₂) to adjust amplitudes of signals thereby received such that power/intensity of the modulated light I responsive to pulse signals generated by the third pulse signal source (P₂) is attenuated to about (μ_{d}/μ)·Iₚₐₜₜₑᵣₙ₁, wherein μ and μ_{d} are predefined uniform average number of photons for main and decoy quantum states respectively.

The QKD transmitter is configured in some embodiments to cause the respective signal manipulating unit of the fourth pulse signal source (P₃) to adjust amplitudes of signals thereby received such that power/intensity of the modulated light I responsive to pulse signals generated by the fourth pulse signal source (P₃) is attenuated to a mid-decoy level I_{pattern2d}=β·Iₚₐₜₜₑᵣₙ₁, wherein β<α is predefined mid-intensity level setting factor. The QKD transmitter can be configured to cause the respective signal manipulating unit of the fourth pulse signal source (P₃) to adjust amplitudes of signals thereby received such that power/intensity of the modulated light I responsive to pulse signals generated the third and fourth pulse signal source (P₂ and P₃) is attenuated to the mid-decoy level I_{pattern2d}.

The QKD transmitter is configured in some embodiments to cause the respective signal manipulating unit of the first and/or second pulse signal sources (P₀ and/or P₁) to adjust time delay of signals thereby received such that power/intensity of the modulated light I responsive to pulse signals generated by the first and second pulse signal sources is minimized. The QKD transmitter can be configured to cause the respective signal manipulating unit of the third pulse signal sources (P₂) to adjust time delay of signals thereby received such that power/intensity of the modulated light I responsive to pulse signals generated by the second and third pulse signal sources (P₁ and P₂) is minimized. The QKD transmitter can be configured to cause the respective signal manipulating unit of the fourth pulse signal sources (P₃) to adjust time delay of signals thereby received such that power/intensity of the modulated light I responsive to pulse signals generated by the third and fourth pulse signal sources (P₂ and P₃) is minimized.

In possible embodiments the quantum communication states comprise four main quantum states, four decoy states, and one vacuum state. In other possible embodiments the quantum communication states comprise four main quantum states, a different of quantum states (e.g., any number of decoy states) as may be required by other QKD protocols, and one vacuum state. The QKD transmitter comprises in some embodiments a power meter (e.g., comprising a photodiode) configured to measure optical output power/intensity of the modulated light signals and generate measurement data/signals indicative thereof, and a control unit configured and operable to adjust at least one of the plurality of signal manipulating units and/or the output tuneable gain unit based on the measurement data/signals.

The system can be configured to receive feedback data/signals indicative of interference (destructive or constructive) visibility obtained in response to transmitted optical signals, and the control unit can be configured adjust at least one of a frequency of a clock unit thereof and pulse time difference of the pulse signals based on the feedback data/signals.

In another aspect there is provided a QKD transmitter's calibration method comprising: generating a plurality pf pulse signals, voltage polarity of at least one of the plurality of pulse signals is opposite to a voltage polarity of at least another one of the plurality of pulse signals; combining the plurality of pulse signals and generating therefrom a light-modulating signal; modulating light signal by the light-modulating signal; measuring the modulated light signals and generating measurement data indicative thereof, and adjusting at least one of amplitude and delay time of at least some of the plurality of pulse signals to obtain/communicate a desired quantum communication state. The method comprises in some embodiments combining first, second and third, pulse signals to generate the light-modulating signal, wherein the second pulse signal (P₁) having the opposite voltage polarity.

The method can comprise generating at least one main quantum state by the pulse signal source configured to generate the pulse signals with the opposite voltage polarity without combining it with the other pulse signals. The method can comprise adjusting amplitudes of the first pulse signal and of the light-modulating signal such that power/intensity I of the modulated light signals responsive to the first pulse signal is attenuated by a predefined upper-level intensity setting factor α to about α·I, wherein 0.95≤α<1.

The method comprises in some embodiments adjusting amplitude of the second pulse signal (P₁) such that power/intensity of the modulated light signals I responsive to the first pulse signal (P₀) is attenuated by a predefined mid-intensity level setting factor β to about β·I, wherein β<α. The methods can comprise adjusting the first pulse signal (P₀) such that power/intensity of the modulated light signals I responsive to the first and second pulse signals (P₀ and P₁) is attenuated by an upper-mid-level intensity setting factor γ to an upper-mid-level power/intensity I_{β}, wherein β<γ<α. The methods can further comprise adjusting amplitude of the third pulse signal (P₂) such that power/intensity of the modulated light signals I responsive to the first, second and third, pulse signals (P₀, P₁ and P₂) is attenuated to the upper-mid-level power/intensity I_{β}. The method may also comprise adjusting amplitudes of the third pulse signal (P₂) such that power/intensity of the modulated light signals I responsive to the second and third pulse signals (P₁ and P₂) is attenuated to about half of the upper-mid-level power/intensity I_{β}.

In some embodiments the method comprises adjusting time delay of the first and/or second pulse signals (P₀ and/or P₁) such that power/intensity of the modulated light signals I responsive to the first and second pulse signals is minimized. The method can comprise adjusting time delay of the third pulse signal source (P₂) such that power/intensity of the modulated light signals I responsive to the second and third pulse signals is minimized.

The method comprises in some embodiments generating the light modulating signal by combining two pairs of the pulse signals, wherein each of the pairs pulse signals are of opposite voltage polarities. The method can comprise generating main quantum states from one pair of the pulse signals, and generating decoy states from the other pair pulse signals. The method can further comprise adjusting amplitudes of the first pulse signal (P₀) and of the light-modulating of signals such that power/intensity of the modulated light signals I responsive to the first pulse signal (P₀) is attenuated by a predefined upper-level intensity setting factor α to an upper-level power/intensity Iₚₐₜₑᵣₙ₁=α·I, wherein 0.95≤α<1.

The method may comprise adjusting amplitude of the second pulse signal (P₁) such that power/intensity of the modulated light signal I responsive to the second pulse signal (P₁) is attenuated to a mid-intensity level Iₚₐₜₜₑᵣₙ₂ of about β·Iₚₐₜₜₑᵣₙ₁, wherein β<α is predefined mid-intensity level setting factor. Optionally, the method comprises adjusting amplitude of the second pulse signal (P₁) such that power/intensity of the modulated light signals I responsive to the first and second pulse signal (P₀ and P₁) is attenuated to a fine-tuned-intensity level Iₚₐₜₜₑᵣₙ₃ of about Iₚₐₜₜₑᵣₙ₂.

The method comprises in some embodiments adjusting amplitude of the third pulse signal (P₂) such that power/intensity of the modulated light signals I responsive to the third pulse signal (P₂) is attenuated to about μ_{d}/μ·Iₚₐₜₜₑᵣₙ₁, wherein μ and μ_{d} are predefined uniform average number of photons for main and decoy quantum states respectively. The method can comprise adjusting amplitude of the fourth pulse signal (P₃) such that power/intensity of the modulated light signals I responsive to the fourth pulse signal (P₃) is attenuated to a mid-decoy level I_{pattern2d}=β·Iₚₐₜₜₑᵣₙ₁, wherein β<α is predefined mid-intensity level setting factor. Optionally, the method comprises adjusting amplitude of the fourth pulse signal (P₃) such that power/intensity of the modulated light signal I responsive to the third and fourth pulse signal (P₂ and P₃) is attenuated to the mid-decoy level I_{pattern2d}.

The comprises in some embodiments adjusting a time delay of the first and/or second pulse signal (P₀ and/or P₁) such that power/intensity of the modulated light signals I responsive to the first and second pulse signal is minimized. The method can comprise adjusting time delay of the third pulse signal (P₂) such that power/intensity of the modulated light signals I responsive to the second and third pulse signal (P₁ and P₂) is minimized. The method can further comprise adjusting a time delay of the fourth pulse signal (P₃) such that power/intensity of the modulated light signals I responsive to the third and fourth pulse signal (P₂ and P₃) is minimized.

The method may comprise receiving feedback data/signals indicative of interference obtained in response to transmitted optical signals, and adjusting at least one of a frequency of a clock unit of the transmitter and pulse time difference of the pulse signals based on the feedback data/signals.

It is noted that calibration techniques disclosed herein advantageously aligns/synchronise pulse signals from multiple pulse source using relatively slow photodiode power meter device to align the pulse signals in substantially high (picoseconds) resolution, and combine them into the light-modulating signal.

### BRIEF DESCRIPTION OF THE DRAWINGS

In order to understand the presently presented subject matter and to see how it may be carried out in practice, embodiments will now be described, by way of non-limiting example only, with reference to the accompanying drawings. Features shown in the drawings are meant to be illustrative of only some embodiments of the presently presented subject matter, unless otherwise implicitly indicated. In the drawings like reference numerals are used to indicate corresponding parts, and in which:

FIGS. 1A to 1C are block diagrams schematically illustrating a QKD transmitter system according to some possible embodiments, wherein FIG. 1A depicts a QKD transmitter utilizing three pulse signals sources, FIG. 1B depicts a QKD transmitter utilizing four pulse signals sources, and FIG. 1C shows a possible implementation of a signal manipulation unit;

FIG. 2 graphically illustrates optical signals of the 4 (four) main quantum communication states and the 5 (five) decoy states according to some possible embodiments;

FIG. 3 graphically illustrates calibration/testing pulse signals according to some possible embodiments;

FIG. 4 is a block diagram schematically illustrating a QKD communication system according to some possible embodiments; and

FIGS. 5A and 5B are block diagrams schematically illustrating calibration sequences usable in some embodiments for calibration of the transmitter systems of FIGS. 1A and 1B respective.

### DETAILED DESCRIPTION OF EMBODIMENTS

One or more specific and/or alternative embodiments of the present disclosure will be described below with reference to the drawings, which are to be considered in all aspects as illustrative only and not restrictive in any manner. It shall be apparent to one skilled in the art that these embodiments may be practiced without such specific details. In an effort to provide a concise description of these embodiments, not all features or details of an actual implementation are described at length in the specification. Emphasis instead being placed upon clearly illustrating the principles of the presently presented subject matter such that persons skilled in the art will be able to make and use the configurations hereof, once they understand the principles of the subject matter disclosed herein. This presently presented subject matter may be provided in other specific forms and embodiments without departing from the essential characteristics described herein.

The QKD transmitter systems of the present application are configured to generate light-modulating signals by combining a plurality of electric/EM pulse signals passed through signal manipulation units configured to adjust at least one of amplitude and time delay of at least some of the electric/EM pulse signals. Optionally, at least the amplitude of the light modulating signal is adjusted before it is input to an electrooptic modulator of the QKD transmitter for encoding the quantum communication states to light signal received from a coherent (e.g., laser) light source. System calibration and/or testing procedures can be carried out from time to time, or periodically/routinely, in between QKD sequences performed during the system operation, by scanning for at least some of the electric/EM pulse signal sources test values for at least one of gain and time delay, measuring the optical signals generated by the electrooptical modulator responsive to the scanned test values, and determining based thereon optimal gain and/or time delay for the electric/EM pulse signals of at least some of the electric/EM pulse signal sources.

For an overview of several example features, process stages, and principles of the presently presented subject matter, the transmitter examples illustrated schematically and diagrammatically in the figures are intended for QKD communication. These transmitter systems are shown as one example implementation that demonstrates a number of features, processes, and principles used to provide self-calibratable QKD transmitter implementations, but they are also useful for other applications and can be made in different variations. Therefore, this description will proceed with reference to the shown examples, but with the understanding that the presently presented subject matter recited in the claims below can also be implemented in myriad other ways, once the principles are understood from the descriptions, explanations, and drawings herein. All such variations, as well as any other modifications apparent to one of ordinary skill in the art and useful in QKD communication applications may be suitably employed, and are intended to fall within the scope of this disclosure.

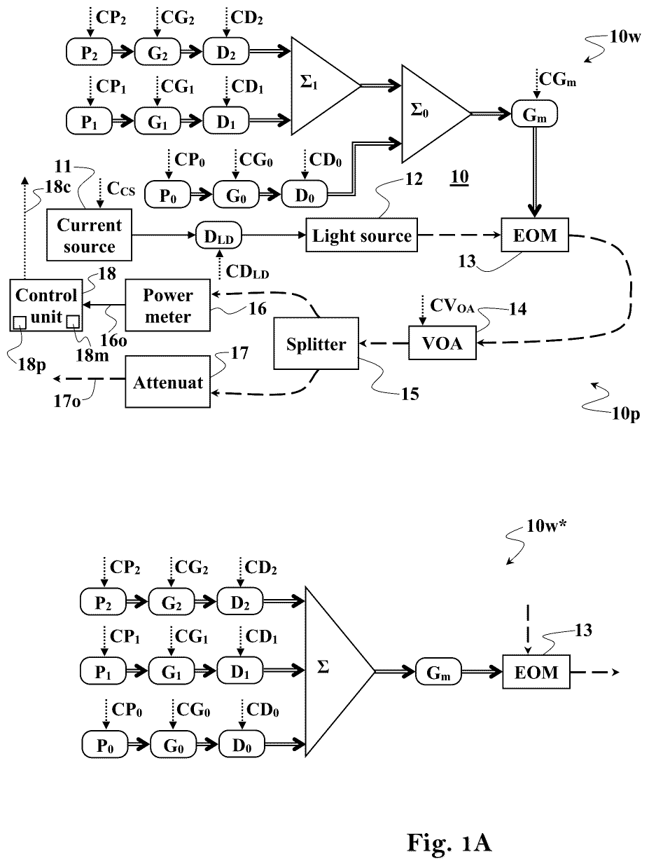

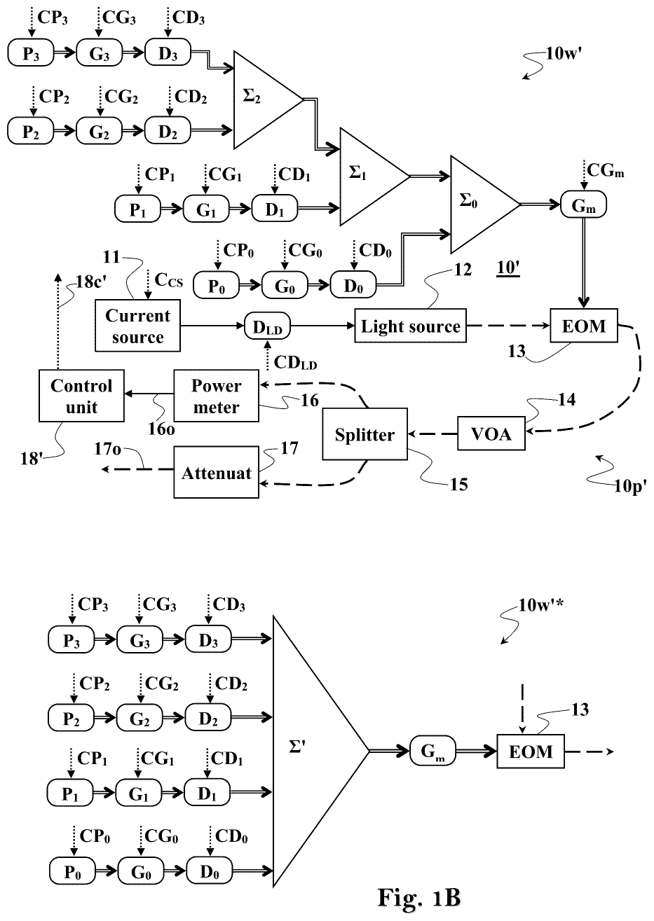

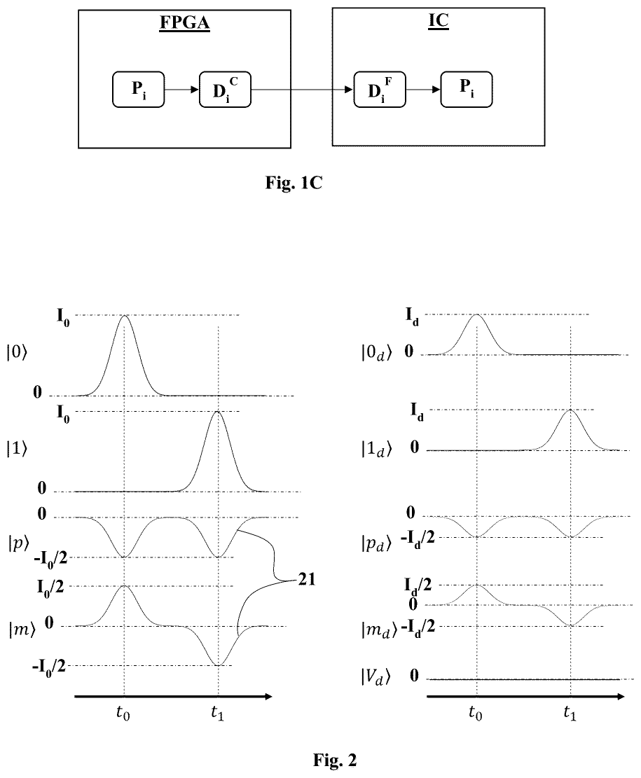

FIG. 1A schematically illustrates a QKD transmitter system 10 according to some possible embodiments of the present application. The QKD transmitter system 10 comprises a modulator driving portion 10w, wherein electric/electromagnetic (EM e.g., radiofrequency—RF) signals generated by three or more pulse signal sources P₀, P₁, P₂, . . . (e.g., electric/EM signal sources such as produced by FPGA's Serializer/Deserializer (SerDes) or digital-to-analog converters, or other pulse generators) propagate over electromagnetic signal guiding elements (designated by double-lined arrowed lines e.g., RF/microwave waveguides), and an optical light modulating portion 10p wherein optical signals generated by a coherent (e.g., laser) light source 12 propagate over optical signal guiding elements (designated by dashed arrowed lines e.g., optical fibers).

In this non-limiting example the QKD transmitter system 10 comprises in the modulator driving portion 10w three pulse signal sources P₀, P₁ and P₂, and two analog signal combiners Σ₀ and Σ₁ configured to produce desired combinations of electric pulse signals generated by the pulse signal sources P₀, P₁ and P₂. Particularly, each one of the combiners Σ₀ and Σ₁ (e.g., implemented by dedicated IC and/or electrical resistors circuitry) is configured to combine (superposition) the two electromagnetic signals received at its input terminals into a single electromagnetic output signal that is substantially proportional to summation of the electromagnetic signals inputted thereto. In some embodiments each one of the analog combiners Σ₀ and Σ₁ has a 6 dB (i.e., half voltage amplitude attenuation) insertion loss.

For example, in some embodiments the pulse signal sources P₀, P₁ and P₂, and the analog combiners Σ₀ and Σ₁, are configured as follows:
Pulse signal source P₀: configured to generate positive electric/EM pulse signals that passes through the analog combiner Σ₀, which output towards the EOM 13 thus includes ½ (half) of the initial voltage level received from the pulse signal source P₀;
Pulse signal source P₁: configured to generate negative electric/EM pulse signals that passes through the two analog combiners, Σ₀ and Σ₁, which output towards the EOM 13 thus includes ¼ (quarter) of the initial voltage level received from the pulse signal source P₁; and
Pulse signal source P₂: configured to generate positive electric/EM pulse signals that passes through the two analog combiners, Σ₀ and Σ₁, which output towards the EOM 13 thus includes ¼ (quarter) of the initial voltage level received from the pulse signal source P₂.

In some embodiments the electric/EM pulse signals generated by one or more of the pulse signal sources Pᵢ (where 0≤i≤2 is an integer number) is passed through a respective tuneable gain unit Gᵢ configured to controllably adjust the amplitude of the electric/EM pulse signals generated by the pulse signal sources Pᵢ, before it reaches the analog combiner(s). The combined signal generated by the last analog combiner Σ₀ in the modulator driving portion 10w is used as a light-modulating signal for modulation of optical signals by the electrooptic modulator (EOM, or modulators in some implementations) 13 provided in the light modulating portion 10p of the transmitter system 10.

The light-modulating signal generated by the last combiner Σ₀ is controllably adjusted in some embodiments by a tuneable output gain unit (e.g., amplifier, or amplifier chain, having a tuneable total gain) Gₘ of the modulator driving portion 10w, before it is input into the EOM 13. Optionally, the controllable gain unit Gₘ is an integral part of the EOM 13, and in such possible embodiments it can be omitted from the transmitter system 10. In possible embodiments the gain of the tuneable gain units Gᵢ is high enough to render the output gain unit Gₘ redundant and discardable.

Optionally, but in some embodiments preferably, the electric/EM signals produced by one or more of the tuneable gain units Gᵢ is passed through a respective tuneable delay unit Dᵢ configured to controllably apply a desired time delay to the electric pulse signal thereby received, before it reaches the analog combiner(s). The tuneable gain Gᵢ and delay Dᵢ units of each pulse signal source Pᵢ are also referred to herein as a signal manipulation unit, which may be implemented as a single integrated device/unit, or inside the respective pulse signal source Pᵢ. Optionally, but in some embodiments preferably, functionalities of this signal manipulation sequence are distributed over two or more separate devices/units (e.g., microchips), as exemplified in FIG. 1C.

In the specific and non-limiting example of FIG. 1C, the pulse signal units Pᵢ are implemented in a first device/unit (e.g., FPGA microchip), the tuneable gain units G are implemented in a second device/unit (e.g., application-specific integrated circuit—ASIC/IC microchip) which may be (e.g., 30-50 times) faster, or slower, than the first device/unit. Optionally, but in some embodiments preferably, functionalities of one or more of the pulse signal Pᵢ, tuneable delay Dᵢ, and/or gain Gᵢ units, is distributed between the first and second device/units (e.g., FPGA and IC) in accordance with their performance requirements.

It is noted that the embodiments disclosed herein can be advantageously exploited for other applications requiring fast analog signal generation, and/or for fast generation of accurate analog signals. Due to the ability to use standard digital SerDeses to generate positive and negative analog signals levels at the same or similar rate.

For example, in possible embodiments, each tuneable delay unit Dᵢ can be configured to apply a “coarse” delay part Dᵢ^{C} e.g., having a defined (logical) 1 (one) bit resolution, and a “fine” delay part Dᵢ^{F} e.g., having a defined (physical) sub-bit resolution. The “fine” (sub-bit) delay part Dᵢ^{F} is achieved in some embodiments utilizing a dedicated integrated circuit (IC e.g., allowing 1 to 5, optionally about 3, picoseconds increments) with different conduction paths e.g., formed on a printed circuit board (PCB), by controllably adjusting conducting path/wire lengths, and/or by controllably adjusting the electronic paths, and the “coarse” delay part Dᵢ^{C} is implemented by logical delay units implemented in a field-programmable gate array (FPGA e.g., allowing 80 to 120, optionally about 100, picoseconds increments) chip.

It is noted that the delay units D₀ and D₁ can have the same role in possible calibration processes of the system 10, and thus, in such embodiments, one of them can be omitted. However, in the embodiments exemplified in FIG. 1A both delay units D₀ and D₁ are used in the QKD transmitter system 10 in order to keep the electric/EM signal shape identical in all of the paths of the modulator driving portion 10w. In some embodiments one or more of the tuneable delay units Dᵢ is implemented by a digital regenerative IC, and can act as an amplifier and/or inverter, if so required.

The light modulating portion 10p of the system 10 comprises a coherent (e.g., laser) light source 12 powered by the electrical current source 11, the EOM 13 that modulates the desired quantum communication states in the light signal generated by the light source 12, and a variable optical attenuator (VOA) unit 14 configured to controllably set a desired attenuation factor to the modulated optical pulse signals produced by the EOM 13. As seen, the power/intensity of the modulated optical pulse signals from the EOM 13, or after passage through the VOA 14, or some portion thereof, can be further attenuated by a fixed optical attenuation unit 17 e.g., to the single-photon power level.

An optical splitter (or a signal tap) 15 is used in some embodiments to branch some predefined portion (e.g., half power signal) of the modulated optical pulse signals e.g., from the EOM 13 or after passage through the VOA 14, into a power meter unit 16. The power meter unit 16 can be implemented by a photodiode configured to measure the power/intensity of the optical signal thereby received. Unless specifically specified, for most stages of the initialization procedures disclosed herein, there is no need to calibrate the power meter unit 16 in the embodiments wherein it is implemented with a photodiode. In some of the disclosed embodiments there is also no need to calibrate the VOA 14.

Optionally, the electric current generated by the current source 11 is passed through a tuneable delay unit D_{LD} configured to controllably delay the electric driving current of the light source 12, as required in some embodiments for direct modulation of the generated light signal relative to all other pulse signal sources in the system e.g., for ON/OFF periodic switching the light source in order to adapt the light signal timing such that the signal modulation is applied by the EOM 13 during the “ON” time intervals correctly.

A control unit 18 having one or more processors 18p and memories 18m is used in possible embodiments to operate the different units of the system 10 and set one or more parameters of its different components/units. The control unit 18 can be configured to process the measurement data/signals 16o generated by the power meter 16 and determine based thereon calibration values for one or more of the components of the system 10 e.g., using one or more of the calibration sequences disclosed hereinbelow or hereinabove. The calibration values can be set by one or more of the control signals CPᵢ, CGᵢ, CGₘ, CDᵢ, CD_{LD}, CV_{OA}, (designated by dotted arrowed lines, collectively referred to herein as control signals 18c) generated by the control unit 18. This way, a closed feedback loop is obtained and utilized for calibrating and/or testing the QKD transmitter system 10.

For example, the control unit 18 can be configured to generate (e.g., ON/OFF) control signals CPᵢ for operating one or more of the electric pulse sources Pᵢ, and/or control signals CGᵢ and/or CGₘ to set gain factor/value of at least one of the tunable gain units Gᵢ and/or Gₘ for thereby applying a desired gain to the electric/EM pulse signals thereby received, and/or control signals CDᵢ and/or CD_{LD} to set time delay value of at least one of the tuneable delay units Dᵢ and/or D_{LD} for thereby applying a desired time delay to the electric/EM pulse signals thereby received, and/or control signals CV_{OA} to set an attenuation factor/value of the tuneable attenuation unit VOA for thereby applying a desired attenuation factor to the optical signals thereby received.

In some possible embodiments the delay time applied by the tuneable delay unit D_{LD} is implemented internally by the current source 11, which may render the tuneable delay unit D_{LD} redundant and discardable. Accordingly, the current source 11 can also receive a control signal C_{CS} from the control unit 18 for setting its internal time delay.

It is noted that other arrangements utilizing one or more analog combiner units can be used to obtained substantially the same functionality of the QKD transmitter system 10. For example, FIG. 1A further demonstrates a possible embodiment of the modulator driving portion 10w* of the QKD transmitter system 10 utilizing a single (3:1) analog combiner unit Σ to produce the light modulating signal.

FIG. 1B schematically illustrates a QKD transmitter system 10′ according to other possible embodiments of the present application. The QKD transmitter 10′ resembles in many aspects the QKD transmitter 10 of FIG. 1, but inter alia differs therefrom in that its modulator driving portion 10w′ comprises an additional electric/EM pulse signal source, an additional analog signal combiner Σ₂, an additional tuneable gain unit G₃ configured to controllably adjust the amplitude of the electric/EM pulse signals generated by the additional pulse signal source P₃, an additional tuneable delay unit D₃ for applying a desire delay time to the electric/EM pulse signals from the additional tuneable gain unit G₃, and respective additional electromagnetic signal guiding elements for connecting these units.

The pulse signal sources P₀, P₁, P₂ and P₃, and the analog combiners Σ₀, Σ₁ and Σ₂, are configured as follows:
Pulse signal source P₀: configured to generate positive pulse signals that passes through the analog combiner Σ₀, which output towards the EOM 13 includes ½ (half) of the initial voltage level received from the pulse signal source P₀;
Pulse signal source P₁: configured to generate negative pulse signals that passes through the analog combiners Σ₀ and Σ₁, which output towards the EOM 13 thus includes ¼ (quarter) of the initial voltage level received from the pulse signal source P₁;
Pulse signal source P₂: configured to generate positive pulse signals that passes through the analog combiners Σ₀, Σ₁ and Σ₂, which output towards the EOM 13 thus includes ⅛ (eighth) of the initial voltage level received from the pulse signal source P₂; and
Pulse signal source P₃: configured to generate negative pulse signals that passes through the analog combiners Σ₀, Σ₁ and Σ₂, which output towards the EOM 13 thus include ⅛ (eighth) of the initial voltage level received from the pulse signal source P₃.

Similarly, FIG. 1B illustrates using both of the delay units D₀ and D₁ in order to keep the electric/EM signal shape identical in all of the paths of the modulator driving portion 10w′ of the system 10, but as mentioned hereinabove, the delay units D₀ and D₁ can have the same role in possible calibration processes of the system 10′, and thus in such embodiments one of them can be omitted. The light modulating portion 10p′ of the system 10′ similarly comprises the coherent (e.g., laser) light source 12 powered by the electrical current source 11, the EOM 13 used to modulate the desired quantum communication states in the light signal generated by the light source 12, and the variable optical attenuator (VOA) unit 14 for controllably setting a desired attenuation factor to the modulated optical pulse signals produced by the EOM 13. The power/intensity of the modulated optical pulse signals from the EOM 13, or after passage through the VOA 14, or some portion thereof, can be similarly further attenuated by a fixed optical attenuation unit 17 e.g., to the single-photon power level.

The optical splitter (or a signal tap) 15 can be similarly used in some embodiments to branch some predefined portion (e.g., half power signal) of the modulated optical pulse signals from the EOM 13, or from the VOA 14, into the power meter unit 16. Correspondingly, calibration of the power meter unit 16 in embodiments wherein it utilizes a photodiode is required in only some of the initialization procedures disclosed herein.

The control unit 18′ is similarly configured to operate components of the transmitter system 10′. The control unit 18′ can be configured to process the measurement data/signals generated by the power meter 16 and determine based thereon calibration values for one or more of the components of the system 10′ e.g., using one or more of the calibration/testing sequences disclosed herein. The control unit 18′ can be accordingly configured to set calibration values by one or more of the control signals CPᵢ (where 0≤i≤3 is an integer number), CGᵢ, CGₘ, CDᵢ, CD_{LD}, CV_{OA}, (designated by dotted arrowed lines, collectively referred to herein as control signals 18c′) thereby generated. In this way, a closed feedback loop is obtained, that can be used for calibrating and/or testing the transmitter system 10′.

It is noted that other arrangements utilizing one or more analog combiner units can be used to obtained substantially the same functionality of the QKD transmitter system 10′. For example, FIG. 1B further demonstrates a possible embodiment of the modulator driving portion 10w′* of the QKD transmitter system 10′ utilizing a single (4:1) analog combiner unit Σ′ to produce the light modulating signal.

It is noted that losses in the transmitter system 10 and/or 10′ are considered as having “ideal” losses in the present disclosure, for the sake of simplicity. Excess insertion losses, though addressed by the initialization procedures hereof, are generally ignored in the present disclosure for the sake of clarity. The electrical/EM pulses combined to form the light-modulating signal are configured to “carve” the light signal from the light source 12 into optical pulses forming the quantum communication states of the system. The optical power/intensity of the modulated optical pulses depends on the transfer function of the EOM 13 (e.g., proportional to sin²), as exemplified in Table 1. The EOM 13 can be implemented by a Mach Zehnder modulator. Optionally, but in some embodiments preferably, the EOM 13 is implemented by a single-drive (or dual-drive) Mach Zehnder modulator using any of the embodiments disclosed in International Patent Publication No. WO 2022/003704 of the same applicant hereof, the disclosure of which is incorporated herein by reference.

For example, in order to generate time-bin encoding of the 9 (nine) quantum communication states required for operation of a two-decoy state BB84 protocol, or other derivatives of the BB84 protocol i.e., the quantum states |0 [symbol] , |1 [symbol] , |p [symbol] , |m [symbol] , the decoy states |0_{d} [symbol] , |1_{d} [symbol] , |p_{d} [symbol] , |m_{d} [symbol] , and the vacuum state |V_{d} [symbol] , the following electrical/EM pulses are injected in some embodiments into the EOM 13:
   |0 [symbol] : Pulse at to with voltage amplitude v₀ and no pulse at t₁;
   |1 [symbol] : No pulse at t₀ and a pulse at t₁ with voltage amplitude of v₀;
   |p [symbol] : Pulse at t₀ with voltage amplitude −v₀/2 and pulse at t₁ with voltage amplitude −v₀/2;
   |m [symbol] : Pulse at t₀ with voltage amplitude v₀/2 and pulse at t₁ with voltage amplitude −v₀/2 (inverted polarity);
   |0_{d} [symbol] : Pulse at t₀ with voltage amplitude v_{d} and no pulse at t₁;
   |1_{d} [symbol] : No pulse at t₀ and a pulse at t₁ with voltage amplitude v_{d};
   |p_{d} [symbol] : Pulse at t₀ with voltage amplitude −v_{d}/2 and pulse at t₁ with voltage amplitude −v_{d}/2;
   |m_{d} [symbol] : Pulse at t₀ with voltage amplitude v_{d}/2 and pulse at t₁ with voltage amplitude −v_{d}/2 (inverted (inverted polarity); and
   |V_{d} [symbol] : No pulse is sent.
wherein t₀ is the first time slot of the transmission frame of the qubit, t₁ is the second time slot of the transmission frame of the qubit, τ is the time interval between t₀ and t₁, v₀ is a voltage level of the combined electrical/EM pulse signal required for producing a desired intensity/power I₀ of the optical signal of the |0 [symbol] and |1 [symbol] main quantum states, and v_{d} is a voltage level of the combined electrical/EM pulse signals required for producing a desired intensity/power I_{d} of the optical signal of the decoy states, which can be greater or smaller than v₀ (v_{d}≠v₀, and in some embodiments v_{d}<v₀).

FIG. 2 graphically illustrates optical signals of the 4 (four) main quantum communication states, and the 5 (five) decoy states, according to some possible embodiments. It is understood that the optical pulse illustrations provided in FIG. 2 are of the proportional optical fields, as optical signals having negative power/intensity are not actually feasible. In practice, it is the opposite phase of the modulated optical signals 21 that gives the optical field the negative (“−”) sign.

It is noted in this respect that though the transmitter system 10 of FIG. 1A has the advantage of requiring less system resources, on the other hand it requires superposition of all 3 (three) pulse signal sources P₀, P₁ and P₂, to generate the 9 (nine) quantum communication states. Thus, in the transmitter system 10 configuration of FIG. 1A, the optical power/intensity I_{d} characterizing the decoy states depends on the optical power/intensity I₀ characterizing the main quantum states. On the other hand, the transmitter system 10′ of FIG. 1B is flexible in determining the levels of the decoy states, as the main quantum states can be generated with the two pulse signal sources P₀ and P₁, and the decoy states can be generated separately/independently using two different pulse sources, P₂ and P₃. Thus, in the transmitter system 10′ of FIG. 1B, the optical power/intensity I_{d} characterizing the decoy states does not depend on the optical power/intensity I₀ characterizing the main quantum states.

The 9 (nine) quantum communication states can be generated in the transmitter system 10 configurations of FIG. 1A by setting the tuneable gain units Gᵢ and Gₘ such that:
the amplitude of the pulse signal generated by the P₀ pulse signal source after passing through the tuneable gain unit Gₘ is ⅚V_{π};
The amplitude of the pulse signal generated by the P₁ pulse signal source after passing through the tuneable gain unit Gₘ is

$$- \frac{3}{6} {V}_{π} ;$$

and
The amplitude of the pulse signal generated by the P₂ pulse signal source after passing through the tuneable gain unit Gₘ is ⅙V_{π}.
   wherein V_{π} designates pulse voltage level for full transmission by the EOM 13. It is however noted that the embodiments disclosed herein do not necessitate setting the EOM 13 into full transmittance, and will actually work properly also if a voltage level that is close to (not exactly) V_{π} is used for producing the optical power/intensity I₀ characterizing the main quantum states by the EOM 13.

As seen in FIGS. 1A and 1B, the pulse signals produced by the tuneable gain unit Gₘ are used to encode the main quantum and decoy states by the EOM 13. Using the above-indicated amplitudes with the correct pulse signals' superposition allow an efficient implementation of decoy state BB84 protocol, or other derivatives of the BB84 protocol. It is noted that this is the only amplitude ratio that can generate the required states with the same optical power/intensity for the main states, and the same optical power/intensity for the decoy states (except the vacuum state) for the transmitter system 10 of FIG. 1A (other than inverting all the electric signs).

TABLE 1
generating the 9 (nine) quantum states by the transmitter system 10
of FIG. 1A

| | Pulse | Pulse | | | | |
|---|---|---|---|---|---|---|
| | sources | sources | voltage | voltage | Optical | Optical |
| State | @t₀ | @t₁ | @t₀ | @t₁ | power @t₀ | power @t₁ |
| \|0 [symbol] | P₀, P₂ | None | V_{π} | 0 | I₀ | 0 |
| \|1 [symbol] | none | P₀, P₂ | 0 | V_{π} | 0 | I₀ |
| \|p [symbol] | P₁ | P₁ | $- \frac{1}{2} {V}_{π}$ | $- \frac{1}{2} {V}_{π}$ | I₀/2 | I₀/2 |
| \|m [symbol] | P₀, P₁, P₂ | P₁ | $\frac{1}{2} {V}_{π}$ | $- \frac{1}{2} {V}_{π}$ | I₀/2 | I₀/2 |
| \|0_{d} [symbol] | P₀, P₁, P₂ | None | $\frac{1}{2} {V}_{π}$ | 0 | I₀/2 | 0 |
| \|1_{d} [symbol] | none | P₀, P₁, P₂ | 0 | $\frac{1}{2} {V}_{π}$ | 0 | I₀/2 |
| \|p_{d} [symbol] | P₀, P₁ | P₀, P₁ | $\frac{1}{3} {V}_{π}$ | $\frac{1}{3} {V}_{π}$ | I₀/4 | I₀/4 |
| \|m_{d} [symbol] | P₀, P₁ | P₁, P₂ | $\frac{1}{3} {V}_{π}$ | $- \frac{1}{3} {V}_{π}$ | I₀/4 | I₀/4 |
| \|Vd [symbol] | None | none | 0 | 0 | 0 | 0 |

The 9 (nine) quantum communication states can be generated in the transmitter system 10′ configurations of FIG. 1B by setting the tuneable gain units Gᵢ and Gₘ such that:
the amplitude of the pulse signal generated by the P₀ pulse signal source after passing through the tuneable gain unit Gₘ substantially equals V_{π};
the amplitude of the pulse signal generated by the P₁ pulse signal source after passing through the tuneable gain unit Gₘ substantially equals

$$- \frac{1}{2} {V}_{π} ;$$

the amplitude of the pulse signal generated by the P₂ pulse signal source after passing through the tuneable gain unit Gₘ substantially equals V_{d}; and
the amplitude of the pulse signal generated by the P₃ pulse signal source after passing through the tuneable gain unit Gₘ substantially equals

$$- \frac{1}{n} {V}_{d} .$$

wherein V_{d} is the bias voltage level for the decoy states (optionally, but not necessarily, V_{d}<V_{π}), n is a positive real number configured such that the optical output of the EOM 13 when applying the V_{d} voltage level thereto is twice the optical power/intensity obtained when applying 1/nV_{d} thereto e.g., I(V_{d})=2·I(V_{d}/n), according to the EOM's non-linear response (see Table 2), wherein I(V) is the transmission function of the EOM 13, so the n parameter can be determined by solving the equation f(x)=2·f(x/n).

TABLE 2
generating the 9 (nine) quantum states by the transmitter system 10′
of FIG. 1B

| | Pulse | Pulse | | | | |
|---|---|---|---|---|---|---|
| | sources | sources | voltage | voltage | Optical | Optical |
| State | @t₀ | @t₁ | @t₀ | @t₁ | power @t₀ | power @t₁ |
| \|0 [symbol] | P₀ | none | V_{π} | 0 | I₀ | 0 |
| \|1 [symbol] | none | P₀ | 0 | V_{π} | 0 | I₀ |
| \|p [symbol] | P₁ | P₁ | $- \frac{1}{2} {V}_{π}$ | $- \frac{1}{2} {V}_{π}$ | I₀/2 | I₀/2 |
| \|m [symbol] | P₁ | P₀, P₁ | $\frac{1}{2} {V}_{π}$ | $- \frac{1}{2} {V}_{π}$ | I₀/2 | I₀/2 |
| \|0_{d} [symbol] | P₂ | none | V_{d} | 0 | I_{d} | 0 |
| \|1_{d} [symbol] | none | P₂ | 0 | V_{d} | 0 | I_{d} |
| Ip_{d} [symbol] | P₃ | P₃ | $- \frac{1}{n} {V}_{d}$ | $- \frac{1}{n} {V}_{d}$ | I_{d}/2 | I_{d}/2 |
| \|m_{d} [symbol] | P₃ | P₂, P₃ | $- \frac{1}{n} {V}_{d}$ | $\frac{1}{n} {V}_{d}$ | I_{d}/2 | I_{d}/2 |
| \|Vd [symbol] | None | none | 0 | 0 | 0 | 0 |

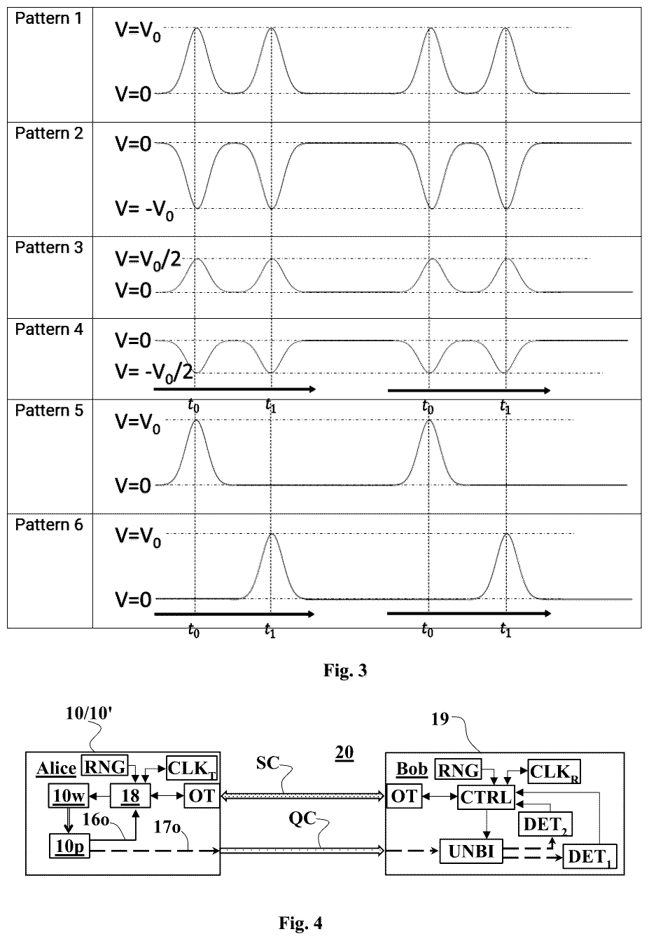

Other optically transmitted patterns/signals are used in some embodiment for system calibration and testing. For example, the pulse signal sources Pᵢ can be configured to transmit predefined electric/EM signal patterns repeatedly/periodically during system initialization stages, for calibrating the transmitter system 10 (0≤i≤2), and/or the transmitter system 10′ (0≤i≤3). The signal patterns graphically illustrated in FIG. 3 exemplify possible patterns that can be generated by the pulse signal sources Pᵢ for the systems' calibration procedures. The amplitude of the signal patterns used in such calibration depends on the pulse signal source used, as every pulse signal source may have different gain parameter and its pulse signals may propagate via different number of combiners of the EM/RF path of its modulator driving portion 10w/10w′.

FIG. 4 is a block diagram schematically illustrating a QKD communication system 20 according to some possible embodiments. In the QKD communication system 20 a standard (classical) communication channel SC (e.g., optical fiber, parallel/serial data/signal communication bus, wireless data/signal communication) is used to exchange data/signals between the QKD transmitter (Alice) 10 (or 10′) and the QKD receiver (Bob) 19 for controlling/orchestrating (e.g., clock synchronization/recovery, sifting, data processing) the QKD protocol steps carried out over the quantum communication channel QC (e.g., optical fiber, free space).

Respective optical transceivers OT can be used in the QKD transmitter 10 (or 10′) and in the QKD receiver 19 for communication data/signals between Alice and Bob over the Sc. The modulated optical pulse signals 17o produced by the optical light modulating portion 10p of the QKD transmitter are transmitted over the QC to the QKD receiver 19. The modulated optical pulse signals from the QC are passed through an unbalanced interferometer UNBI e.g., asymmetric Mach Zehnder or Michelson interferometer, of the QKD receiver 19 and therefrom detected by the light detector(s) e.g., one or more single photon detectors DET₁ and/or DET₂ for detection of different interference patterns. A control unit CTRL of the QKD receiver 19 receives and processes the measurement data/signal generated by the light detector DET, communicates data/signals with the QKD transmitter 10 (or 10′) over the SC, and optionally also synchronizes its clock CLK_{R} with clock signals of the QKD transmitter clock CLK_{T}. A random number generator RNG is also provided in the QKD transmitter 10 (or 10′) and in the QKD receiver 19 for carrying out the QKD protocol.

Optionally, but in some embodiments preferably, the initialization of the QKD system 20 is configured to optimize the frequency of the clock CLK_{T} of the QKD transmitter system 10 (or 10′) to parameters of the receiver's interferometer UNBI. In a time-bin qubit implementation of the QKD protocol, the measurement outcome of the |p [symbol] and |m [symbol] main quantum states depend on the interference of the unbalanced interferometer UNBI at the QKD receiver (i.e., Bob) 19. In some embodiments this is the only step that requires a connection to an external component e.g., Bob/receiver system 19, for receipt of feedback data/signals.

On the other hand, if the Bob receiver system 19 is not connected to a quantum Alice transmitter 10 (or 10′), all the other system initialization steps can be performed with a nominal or other pre-defined clock frequency of the QKD system 20. In this case, however, when connecting the QKD transmitter 10 (or 10′) to a Bob receiver system 19, the frequency of Alice's clock CLK_{T} needs to be adapted to the frequency of Bob's interferometer UNBI, either by measurements as performed in the following initialization step, or to a known, pre-measured frequency.

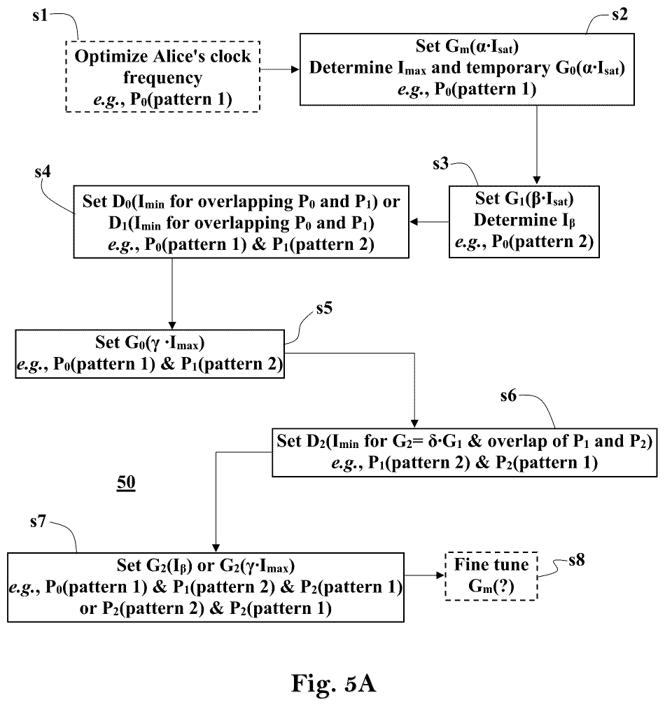

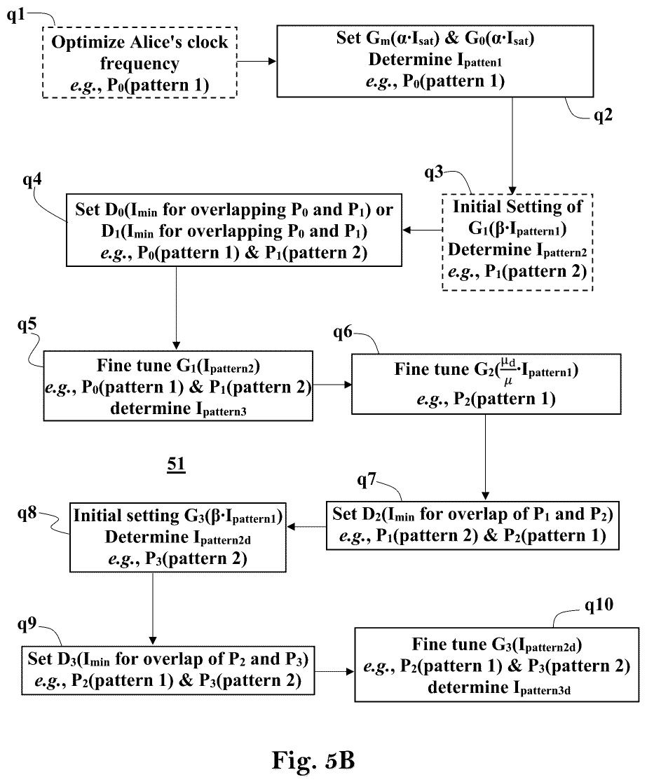

FIG. 5A is a flowchart illustrating an automatic calibration sequence 50 of the transmitter system 10 of FIG. 1A according to some possible embodiments. The calibration sequence 50 may start with an initialization stage (optional step s1 designated by dashed-line box) in which the frequency of clock CLK_{T} of the transmitter system 10 (or 10′) is optimized to parameter(s) of the Bob's receiver system 19. As the arms of Bob's interferometer UNBI are fixed in length for the interference of consecutive optical pulse signals, the available adjustable parameter to maximize this interference is the time difference between the peaks of the amplitudes of the |0 [symbol] and |1 [symbol] main quantum states. This is done in some embodiments by changing this parameter at the QKD transmitter side (Alice) 10 (or 10′) according to feedback data/signals received from the QKD receiver side (Bob) 19 over the SC. In addition, the length difference between the arms of Bob's interferometer UNBI could be regarded as a self-frequency of Bob's interferometer UNBI. In some embodiments the interference visibility (as measured by either the DET₁ or DET₂ detector, or ratio of power signals thereby detected) is maximized at Bob's interferometer UNBI by adjusting the frequency of the clock CLK_{T} of Alice's QKD transmitter system 10 (or 10′), and its repetition rate, which can be achieved utilizing the following procedure:
Transmitted pattern: pattern 1 from the pulse signal source P₀ (as exemplified in FIG. 3).
Procedure: For pattern 1 generated by the pulse signal source P₀ measure the interference visibility at Bob's interferometer UNBI, for optimal constructive and destructive interference. During this procedure the time difference t₁−t₀ between the qubit's pulses t₁ and t₀ can be changed directly at Alice's QKD transmitter 10 (or 10′) by changing the pulse timing of its clock CLK_{T}, and/or by changing the frequency the clock CLK_{T} of the Alice's QKD transmitter. In this specific and non-limiting example a test frequency value for Alice's clock CLK_{T} is scanned starting from a predefined permissible minimal frequency value Frequencyₘᵢₙ, and up to a predefine permissible maximal frequency value Frequencyₘₐₓ. The frequency of the clock CLK_{T} (or the time difference t₁−t₀ between peaks) that returns the best visibility at Bob's QKD receiver 19 is then chosen for use by the Alice's QKD transmitter 10 (or 10′).

### Pseudo Code:

```
Pattern 1
For Frequencyⱼ= Frequencyₘᵢₙ to Frequencyₘₐₓ
  OptimizeVisibility( )
  BobMeasureVisibility(Visibilityⱼ)
End
Frequency= Frequencyⱼ@(OptimalVisibility(Visibilityⱼ))
```

The predefined permissible minimal and maximal frequency values, Frequencyₘᵢₙ and Frequencyₘₐₓ, can be determined based on manufacturing tolerances of the UNBI interferometer.
The Optimize Visibility( ) function is a sequence in which the Alice transmitter changes the wavelength of the (e.g., laser) light source 12 over the free spectral range (FSR) of the UNBI interferometer, with or without feedback from the Bob receiver, which causes the photons to constructively interfere as reflected at one output of the UNBI interferometer (e.g., at DET₁), and to destructively interfere as reflected at the other output of the UNBI interferometer (e.g., at DET₂), and vice versa. It is noted that thermal or mechanical control of the interferometer can be alternatively used to optimize the visibility, and other techniques can be similarly used. With this information the Bob receiver can calculate the visibility of the UNBI interferometer. The BobMeasureVisibility( ) function causes Bob's receiver system 19 to measure the visibility of optical signals received from the transmitter system 10 and transmit the same to the transmitter system 10 over the SC channel e.g., Bob can continuously transmit to Alice over the SC channel the measured visibility, and Alice can then decide which frequency is the optimal frequency to carry out the QKD sequence.
Result: The clock CLK_{T} of Alice's QKD transmitter system and/or the pulse time difference t₁−t₀ are set for optimal interference at Bob's interferometer UNBI.

The configuration of the QKD Transmitter 10 has the minimal number of degrees of freedom for power setting for the pulse signal sources Pᵢ to generate power balanced decoy state BB84 protocol (or other derivatives of the BB84 protocol), in the sense that the configuration of the QKD Transmitter 10 hereof is the only way to generate the 4 (four) main quantum states with a uniform average number of photons per state μ, and the 4 (four) decoy quantum states with a uniform average number of photons per pulse μ_{d}. Based on the limited number of degrees of freedom of the QKD transmitter 10 (or 10′) it can be determined that μ=2μ_{d}. This ratio is efficient for the two-decoy state BB84 protocol (or other derivatives of the BB84 protocol), with the addition of the vacuum state, in which no optical pulses are generated.

Optionally, but in some embodiments preferably, the calibration sequence 50 further comprises a self-calibration procedure (step s2) for the initial setting of the gain factors of the Gₘ and G₀ gain units. This self-calibration procedure is configured to set the electric/EM pulse signal entering the EOM 13 to be close to V_{π} e.g., to about α·V_{π}, where 0.95≤α<1 is an upper-level intensity setting parameter. The Gₘ gain unit is configured to amplify different electric/EM signal levels, and therefore in some embodiments its working point needs to be far from saturation and/or in a linear working region thereof, and/or configured such that it compensates for other non-linearities of the transmitter system 10, such as of the EOM 13 e.g., a Mach-Zehnder electro-optic modulator (MZ EOM). The G₀ gain unit can also reach saturation, as it is typically similar to the gain unit Gᵢ, and the signal pulses generated by the P₀ and P₁ signal pulse sources should keep the same signal shape with different input signal levels/amplitudes. These objectives can be achieved with the following procedure:
Transmitted pattern: pattern 1 from the pulse signal source P₀ (as exemplified in FIG. 3).
Procedure: For a test gain value Gₘⱼ of the gain unit Gₘ scanned starting from a predefined permissible minimal gain value Gₘᵢₙ and up to a predefine permissible maximal gain value Gₘₐₓ, record the intensity/power Iⱼ (16o) of the optical output measured by the power meter 16 for a range of test values G₀ⱼ of the gain unit G₀, starting from a predefined permissible minimal gain value G₀ₘᵢₙ and up to a predefined permissible maximal gain value G₀ₘₐₓ. If optical power saturation of the EOM 13 is recognized, then record the measured saturation power/intensity Iⱼ=Iₛₐₜ and the test gain values Gₘ←Gₘⱼ and G₀←G₀ⱼ for which the measured optical output power/intensity is about 0.95·Iₛₐₜ (where 0.95 is provided as one non-limiting example of a value close to 1, which can provide a desired V_{π}).

### Pseudo Code:

```
For Gₘⱼ = Gₘᵢₙ to Gₘₐₓ
  For G₀ⱼ = G₀ₘᵢₙ to G₀ₘₐₓ
    MeasurePower(Iⱼ)
    If Saturated(I)==true
      G₀←G₀ⱼ(find(j, first, Iₙ>0.95Iⱼ))
      Gₘ←Gₘⱼ(find(j, first, Iₙ>0.95Iⱼ))
      //Iⱼ is the saturation power if Saturated(I)==true
      Iₘₐₓ = Iⱼ
      // Gₘ and G₀ keep their current values
      Break
    End
  End
End
```

Result: the gain value of the gain unit Gₘ is set, a temporary gain value of the gain unit G₀ is determined, and the determined Gₘ and Iₘₐₓ values are recorded.

The function Saturated(I) is configured to recognize that the slope of the output optical power/intensity I vector is close to 0 (zero) for the newly measured optical intensity values Iⱼ, which means that the output optical signal is saturated (not to be confused with the amplifier gain saturation) i.e., in optical saturation increasing the amplitude of the electrical/EM signal supplied to the EOM 13 does not result in an increase in the optical power/intensity of the light signals thereby generated. The predefined permissible minimal and maximal gain values, Gₘᵢₙ, G₀ₘᵢₙ and Gₘₐₓ, G₀ₘₐₓ can be determined by choosing a suitable linear operation regimes of the gain units e.g., according to manufacturer's datasheets.

Optionally, but in some embodiments preferably, the calibration sequence 50 further comprises a self-calibration procedure (step s3) for setting an initial gain factor of the gain unit G₁. As seen in Table 1, the electric/EM pulse signal generated by the pulse signal source P₁ is the only signal transmitted without superposition with other pulses for generation of the main quantum states. Therefore, it is convenient to set the gain value of the gain unit G₁ before setting the gain values of the G₀ and G₂ gain units. The gain unit G₁ is configured to set the electric/EM signal entering the EOM 13 to be close to −β·V_{π}, wherein β<α is a mid-intensity level setting parameter. In some embodiments the mid-voltage level setting parameter is set to β=½, in order to obtain an optical output power/intensity of about ½·Iₘₐₓ, when transmitting pattern 2 by the pulse signal source P₁ i.e., carried out without operating the P₀ and/or P₂ signal pulse sources.
Transmitted pattern: pattern 2 from the P₁ pulse signal source.
Procedure: Record the optical output power/intensity measured by the power meter 16 for a range of G₁ test values, starting from a permissible minimal gain value G₁ₘᵢₙ and up to a permissible maximal gain value G₁ₘₐₓ. The gain value of the G₁ gain unit is set such that the peak of the output optical power/intensity of the measured pulse is ½ (half) of Iₘₐₓ. This is the value for which the average optical output power/intensity of pattern 2 is ½ (half) of the optical output power/intensity of Iₘₐₓ.

### Pseudo Code:

```
For G₁ = G₁ₘᵢₙ to G₁ₘₐₓ
  MeasurePower(Iⱼ)
  If Iⱼ == Iₘₐₓ/2
    I_{1/2} ←Iⱼ
    // G₁ keeps its current value
    Break
  End
End
```

Result: the gain value of the gain unit G₁ is set, and the determined gain value G₁ and the measured mid-intensity optical output level I_{β}=I_{1/2} value and recorded.

The predefined permissible minimal and maximal gain values, G₁ₘᵢₙₙ and G₁ₘₐₓ can be determined by choosing a suitable linear operation regime of the gain unit e.g., according to the manufacturer's datasheet.

Optionally, but in some embodiments preferably, the calibration sequence 50 further comprises a self-calibration procedure (step s4) for setting the pulse signal overlap parameters utilizing the D₀ and/or D₁ time delay units. The following procedure sets the delay time parameters of the delay unit D₀ and/or D₁, such that the positive electric/EM pulse signals generated by the P₀ signal pulse source and the negative electric/EM pulse signals generated by the P₁ signal pulse source overlap in the Σ₀ analog combiner.
Transmitted pattern: pattern 1 generated by the P₀ pulse signal source, and pattern 2 generated by the P₁ pulse signal source. In this way it can be guaranteed that the correct pulse signals overlap i.e., to prevent overlapping pulse n from the P₀ pulse signal source with pulse n+1 from the P₁ pulse signal source, for example.
Procedure: When the overlap between the electric/EM pulse signals generated by the P₀ and P₁ signal pulse sources is acceptable or ideal, the electric/EM pulse power (e.g., root mean square—RMS) from the analog combiners is minimal, and the measured optical output power/intensity Iⱼ is minimal as well. The following procedure scans the pulse position, by scanning test time delay values starting from a predefined permissible minimal delay time value D₀ₘᵢₙ and up to a predefine permissible maximal delay time value D₀ₘₐₓ, to get an optimal overlap. The test time delay value can be defined by either by the D₀ or D₁ delay unit i.e., setting the same delay time value for both the D₀ and D₁ delay units is equivalent to setting a 0 (zero) delay time value for both delay units.

### Pseudo Code:

```
Iₘᵢₙ = MeasurePower(Ij) //initialization
For D₀ⱼ = D₀ₘᵢₙ to D₀ₘₐₓ //can be D₁ instead of D₀
  MeasurePower(Iⱼ)
  If Iₘᵢₙ>Iⱼ
    Iₘᵢₙ ← Iⱼ
  End
End
D₀ = D₀ⱼ(Iⱼ == Iₘᵢₙ)
```

Result: the time delay values of the D₀ and/or D₁ delay units are set so that electric/EM pulse signals from the P₀ and P₁ pulse signal sources substantially overlap in the analog combiners.

The predefined permissible minimal and maximal time delay values, D₀ₘᵢₙ and D₀ₘₐₓ can be determined by the range of possible time delays between the pulse sources e.g., as estimated by the system design.

Optionally, but in some embodiments preferably, the calibration sequence 50 further comprises a self-calibration procedure (step s5) for fine tuning the G₀ gain unit. The G₀ gain unit is set in some embodiments to have a total output optical power/intensity of γ·Iₘₐₓ for the P₀ pulse signal source, when operated with test pattern 1, and without the P₁ pulse signal source or without the P₂ pulse signal source, wherein β<γ<α is an upper-mid-level intensity setting parameter e.g., for α→1 and β→0.5. In some embodiments this procedure is configured to determine a gain value for the G₀ gain unit to provide a total voltage of ⅚·V_{π} (i.e., γ=⅚) for the P₀ pulse signal source when operated with test pattern 1 and without the P₁ or P₂ pulse signal sources.
Transmitted pattern: pattern 1 from the P₀ pulse signal source and pattern 2 from the P₁ pulse signal source.
Procedure: the power of the merged/combined electric/EM pulse signals produced from the Gₘ gain unit is set such that the optical output power/intensity is about ¼ of Iₘₐₓ, by scanning test values for the G₀ gain unit, starting from a predefined permissible minimal gain value G₀ₘᵢₙ and up to a predefine permissible maximal gain value G₀ₘₐₓ.

### Pseudo Code:

For G₀ = G₀ₘᵢₙ to G₀ₘₐₓ
MeasurePower(Iⱼ)
End
G₀= Gⱼ(Iⱼ == Iₘₐₓ/4)

Result: set the gain value for the G₀ gain unit.
The predefine permissible minimal and maximal gain values, G₀ₘᵢₙ and G₀ₘₐₓ, can be determined by choosing a suitable linear operation regime of the gain unit e.g., according to the manufacturer's datasheet.

Optionally, but in some embodiments preferably, the calibration sequence 50 further comprises a self-calibration procedure (step s6) for fine tuning the D₂ delay unit. The D₂ delay unit sets the delay of electric/EM pulse signals generated by the P₂ pulse signal source, such that the electric/EM pulse signals from the P₂ pulse signal source overlap with the electric/EM pulse signals from the P₁ pulse signal source, which thus also overlap with the electric/EM pulse signals from the P₀ pulse signal source.
Pattern: pattern 2 from the P₁ pulse signal source, and pattern 1 from the P₂ pulse signal source.
Procedure: for the purpose of this procedure the gain value of the G₂ gain unit is set to be about δ·G₁, wherein δ<β is a lower-mid-level intensity setting parameter. In some embodiments the lower-mid-level intensity setting parameter is set such that G₂=G₁/3 (δ=⅓). The setting procedure of D₂ is similar to the setting procedure of the D₀ delay unit i.e., test values for the D₂ delay unit are scanned starting from a predefined permissible minimal time delay value D₂ₘᵢₙ and up to a predefine permissible maximal time delay value D₂ₘₐₓ, and the optical output power/intensity is measured. The optimal value of the D₂ delay unit is set such that the measured optical output power/intensity is minimal.
Pseudo code: like the D₀ delay unit procedure but with setting G₂=δ·G₁.
Result: the time delay of the D₂ delay unit is set such that the electric/EM pulses from the P₀, P₁ and P₂, pulse signal sources overlap in the analog combiners.

The predefined permissible minimal and maximal delay time values, D₂ₘᵢₙ and D₂ₘₐₓ, can be determined based on the range of possible time delay between the pulse sources e.g., as estimated by the system design.

Optionally, but in some embodiments preferably, the calibration sequence 50 further comprises a self-calibration procedure (step s7) for fine tuning the G₂ gain unit. The G₂ gain unit is set in some embodiments to optimize the visibility of the |m [symbol] main quantum state, so that the power/intensities of the two optical half-pulses (formed by positive and negative voltage pulses) forming the |m [symbol] main quantum state are substantially identical, and also substantially identical to the power/intensities of the half-pulses forming the |p [symbol] main quantum state. The P₂ pulse signal source is configured in some embodiments to produce a total electric/EM signal of about ⅙·V_{π} when operated without the P₀ pulse signal source, or without the P₁ pulse signal source, with test pattern 1.
Transmitted pattern: pattern 1 from the P₀ pulse signal source, pattern 2 from the P₁ pulse signal source and pattern 1 from the P₂ pulse signal source.
Procedure: the optical output power/intensity is set to about I_{β}=I_{1/2} e.g., the optical power/intensity obtained for the combined electric/EM signals from all of the Gᵢ pulse signal sources should substantially equal to the optical power/intensity obtained for pattern 2 transmitted from the P₁ pulse signal source only (as measured in step s3), by scanning test values for the G₂ gain unit starting from a predefined permissible minimal gain value G₂ₘᵢₙ and up to a predefined permissible maximal gain value G₂ₘₐₓ.

### Pseudo Code:

For G₂ = G₂ₘᵢₙ to G₂ₘₐₓ
MeasurePower(Iⱼ)
end
G₂ = Gⱼ(Iⱼ == I_{1/2})

Result: the gain value of the G₂ gain unit is set for an optimal |m [symbol] main quantum state.

The predefined permissible minimal and maximal gain values, G₂ₘᵢₙ and G₂ₘₐₓ, can be determined by choosing a suitable linear operation regime e.g., according to manufacturer's datasheet.

Alternatively, the fine tuning of the G₂ gain unit is configured to optimize the visibility of the |m_{d} [symbol] decoy state, so that the optical power/intensity of the two half-pulses forming the |m_{d} [symbol] state is substantially identical, and also substantially identical to the optical power/intensity of the two half-pulses forming the |p_{d} [symbol] decoy state. In some embodiments the gain value of the G₂ gain unit is set to provide combined electric/EM output of about ⅙·V_{π}[How is it measured?], when pattern 1 is generated by the P₂ pulse signal source, and without additional pulse source.
Transmitted pattern: pattern 2 from the P₁ pulse signal source and pattern 1 from the P₂ pulse signal source.
Procedure: the combined electric/EM output signal is set to about γ·V_{π} (e.g., for ⅓·V_{π} I→¼·Iₘₐₓ optical output power/intensity), by scanning test values for the G₂ gain unit starting from the predefine permissible minimal gain value G₂ₘᵢₙ and up to the predefine permissible maximal gain value G₂ₘₐₓ.

### Pseudo Code:

For G₂ = G₂ₘᵢₙ to G₂ₘₐₓ
MeasurePower(Iⱼ)
End
G₂ = Gⱼ(Iⱼ == Iₘₐₓ/4)

Result: the gain value of the G₂ gain unit is set for optimal |m_{d} [symbol] decoy state.

Optionally, but in some embodiments preferably, the calibration sequence 50 further comprises a self-calibration procedure (optional step s8, designated by dashed line box) for fine tuning the Gₘ gain unit. In this optional procedure the non-linear response of the EOM 13 can be used to balance the intensity of the various quantum communication states, if so needed e.g., when the total optical output power/intensity of the 4 (four) main quantum states is not uniform, or when the optical output power/intensity of the 4 (four) decoy states is not uniform. Changing the gain value of the Gₘ gain unit will change values close to V_{π}/2 the most, while keeping values close to V_{π} almost unchanged, which thus enables changing the balance between the different quantum communication states e.g., by scanning the test values for the Gₘ gain unit and measuring the power of |0 [symbol] , |1 [symbol] , |p [symbol] , |m [symbol] for each Gₘ value i.e., a Gₘ value can be set for which the power of all main quantum states is substantially equal. Alternatively, the other gain units Gᵢ can be adapted accordingly, without using Gₘ.

FIG. 5B is a flowchart illustrating an automatic calibration sequence 51 of the transmitter system 10′ of FIG. 1B according to some possible embodiments. The calibration sequence 51 may start with an initialization stage (optional step q1 designated by dashed-line box) in which the frequency of clock CLK_{T} of the transmitter system 10 is optimized to parameter(s) of the Bob's receiver system 19. The initialization stage (q1) is similar to the initialization stage (s1) of the automatic calibration sequence 50 of FIG. 1A, and thus will not be described herein again for the sake of brevity.

Optionally, but in some embodiments preferably, the calibration sequence 51 further comprises a self-calibration procedure (step q2) for initial setting of the gain factors of the Gₘ and G₀ gain units. This procedure can be configured to set the electric/EM pulse signals inputted to the EOM 13 to be close to V_{π} e.g., to about α·V_{π} where 0.95≤α<1. The Gₘ gain unit amplifies different signal levels and therefore its working point should be far from saturation, and/or at a linear response working regime thereof, and/or configured to compensate for other non-linearities of the system 10′, such as of the EOM 13. The G₀ gain unit is also sensitive to saturation, as it is substantially identical to the G₁, G₂ and G₃, gain units, and the electric/EM pulse signals generated by the P₀, P₁ and P₂, pulse signal sources should keep the same signal shape with different intensities.
Transmitted pattern: pattern 1 from the P₀ pulse signal source.
Procedure: For a test gain value Gₘⱼ of the gain unit Gₘ scanned starting from the predefine permissible minimal gain value Gₘᵢₙ and up to the predefine permissible maximal gain value Gₘₐₓ, record the optical output intensity/power Iⱼ (16o) of the optical output measured by the power meter 16 for a range of test values G₀ⱼ of the gain unit G₀, starting from a predefined permissible minimal gain value G₀ₘᵢₙ and up to a predefined permissible maximal gain value G₀ₘₐₓ. If optical power saturation of the EOM 13 is recognized, then record the measured saturation power/intensity Iⱼ=Iₛₐₜ and the test gain values Gₘ←Gₘⱼ and G₀←G₀ⱼ for which the measured optical output is about 0.95·Iₛₐₜ (where 0.95 is provided as one non-limiting example of a value close to 1, which can provide a desired V_{π}).

### Pseudo Code:

```
For Gₘ = Gₘᵢₙ to Gₘₐₓ
  For G₀ = G₀ₘᵢₙ to G₀ₘₐₓ
    MeasurePower(Iⱼ)
    If Saturated(I)==true
      G₀ ←G₀ₙ(find(j, first, I_{n>}0.95Iⱼ))
      Gₘ ←Gₘⱼ(find(j, first, I_{n>}0.95Iⱼ))
      //Iⱼ is the saturation power if Saturated(I)==true
      Iₚₐₜₜₑᵣₙ₁ = Iⱼ
      //Gₘ and G₀ keep their current values
      Break
    End
  End
End
```

Result: the gain values of the Gₘ and G₀ gain units are set, the gain values of the Gₘ and G₀ gain units, and the measured optical output power/intensity Iₚₐₜₜₑᵣₙ₁ are recorded.

The function Saturated(I) is configured to recognize that the slope of the optical output I vector is close to 0 (zero) for the new values, which means that the optical signal is saturated.

Optionally, but in some embodiments preferably, the calibration sequence 51 further comprises a self-calibration procedure (step q3) for initial setting gain factor for the G₁ gain unit. This procedure sets the electric/EM signal entering the modulator to be close to −β·V_{π} e.g., close to −0.5·V_{π} (β=0.5). This stage is helpful but not essential (designated by dashed line box).
Transmitted pattern: pattern 2 from the P₁ pulse signal source.
Procedure: Record the output power for a range of test values for the G₁ gain unit, starting from the predefine permissible minimal gain value G₁ₘᵢₙ and up to a predefine permissible maximal gain value G₁ₘₐₓ. The gain value of the G₁ gain unit is set such that the peak of the pulse obtained for the P₁ pulse signal source is ½ (half i.e., β=½) of peak of the pulses obtained for the P₀ pulse signal source. This is the value for which the average optical output power/intensity obtained for pattern 2 from the P₁ pulse signal source is ½ (half) of the optical output power/intensity obtained for pattern 1 from the P₀ pulse signal source. Assuming that the gain unit G₀ is not saturated, then the gain unit G₁ is also not saturated, as it is a similar component. If this is not a valid assumption, saturation test for the gain unit G₁ may be required, and the gain should be set to keep the linear correlation of the optical output power/intensities, while no signal is saturated.

### Pseudo Code:

For G₁ = G₁ₘᵢₙ to G₁ₘₐₓ
MeasurePower(Iₚₐₜₜₑᵣₙ₂ⱼ)
End
G₁ ← G₁(Iₚₐₜₜₑᵣₙ₂ⱼ==Iₚₐₜₜₑᵣₙ₁/2)

Result: the gain value of the G₁ gain unit is set, and the gain value for G₁ and the measured optical output Iₚₐₜₜₑᵣₙ₂ (vector of all gain range) values are recorded.

Optionally, but in some embodiments preferably, the calibration sequence 51 further comprises a self-calibration procedure (step q4) for setting the pulse overlap parameters for the D₀ and D₁ delay units. This procedure sets the delay time parameters of the D₀ and D₁ delay units such that the positive electric/EM pulse signals from the P₀ pulse signal source and the negative electric/EM pulse signals from the P₁ pulse signal source substantially overlap in the analog combiners.
Transmitted pattern: pattern 1 from the P₀ pulse signal source and pattern 2 from the P₁ pulse signal source, which are combined to form pattern 3 when overlapping. This way it is assured that the right pulses overlap i.e., to prevent overlap of pulse n from the P₀ pulse signal source with pulse n+1 from the P₁ pulse signal source, for example.
Procedure: When the overlap is acceptable or ideal, the power (RMS) of the electric/EM pulse signal is minimal, and the optical output power/intensity is minimal as well. The pulse position is scanned to get an optimal overlap. The entire time delay scan range is defined by either the D₀ or D₁ delay unit i.e., setting the same delay for both the D₀ and D₁ delay units is equivalent to setting a zero (0) delay time for both delay units. It is noted that this will however shift the combined pulse relative to the pulse generated from the P₂ pulse signal source.

### Pseudo Code:

```
Iₘᵢₙ = MeasurePower(Iⱼ) //initialization
For D₀ = D₀ₘᵢₙ to D₀ₘₐₓ //can be D₁ as well
  MeasurePower(Iⱼ)
  If Iₘᵢₙ>Iⱼ
    Iₘᵢₙ ← Iⱼ
  End
End
D₀ = D₀ᵢ(Iⱼ == Iₘᵢₙ)
```

Result: the delay value of the D₀ delay unit is set such that the output optical power/intensity obtained is minimal.

Optionally, but in some embodiments preferably, the calibration sequence 51 further comprises a self-calibration procedure (step q5) for fine tuning the G₁ gain unit. Differences in response of the electro optical chain (e.g., amplifier gain and EOM response to different polarity) and/or other non-linearities, may lead to different optical power/intensity of the two half-pulses forming the |m [symbol] main quantum state. In order to get high visibility interference between the first and the second half-pulses of the |m [symbol] main quantum state, it is essential to fine tune the G₁ gain unit.
Transmitted pattern: pattern 1 from the P₀ pulse signal source and pattern 2 from the P₁ pulse signal source, which are combined to form pattern 3.
Procedure: the optical output power/intensity is set to substantially equal to the power/intensity obtained for pattern 2 only (e.g., the optical output power/intensity Iₚₐₜₜₑᵣₙ₂ previously measured in step q3) by scanning test values for the G₁ gain unit starting from the permissible minimal gain value G₁ₘᵢₙ and up to the permissible maximal gain value G₁ₘₐₓ. As Iₚₐₜₜₑᵣₙ₂ᵢ is monotonically increasing (until saturation) and Iₚₐₜₜₑᵣₙ₃ᵢ is monotonically decreasing, there will be a gain value of the G₁ gain unit for which Iₚₐₜₜₑᵣₙ₃ᵢ==Iₚₐₜₜₑᵣₙ₂ᵢ, which is used in some embodiments as the optimal gain value for the G₁ gain unit.

### Pseudo Code:

For G₁ = G₁ₘᵢₙ to G₁ₘₐₓ
MeasurePower(Iₚₐₜₜₑᵣₙ₃ⱼ)
End
G₁ = Gⱼ(Iₚₐₜₜₑᵣₙ₃ⱼ == Iₚₐₜₜₑᵣₙ₂ⱼ)
Iₚₐₜₜₑᵣₙ₃ ← (Iₚₐₜₜₑᵣₙ₃ⱼ == Iₚₐₜₜₑᵣₙ₂ⱼ)

Result: the gain value of the G₁ gain unit is set for high visibility of the |m [symbol] main quantum state, with the same power as the |p [symbol] main quantum state, and the gain value for the G₁ gain unit, and the measured optical output power/intensity Iₚₐₜₜₑᵣₙ₃ values are recorded.

Optionally, but in some embodiments preferably, the calibration sequence 51 further comprises a self-calibration procedure (step q6) for fine tuning the G₂ gain unit. In the transmitter system 10′, the P₂ and P₃ signal pulse sources act similar to the P₀ and P₁ signal pulse source, but generate the decoy states and not the main quantum states. Therefore, the target bias voltage of the P₂ and P₃ signal pulse sources is not V_{π}, but a different (normally lower) voltage value, V_{d}, intended to get an output optical power of I_{d} (e.g., I_{d}<I₀). Therefore, the parameter tuning of the G₂ gain unit, the D₂ delay unit, the G₃ gain unit and the D₃ delay unit, utilizes in some embodiments a procedure that is similar to the procedure used for tuning the G₀ gain unit, the D₀ delay unit, the G₁ gain unit, and the D₁ delay unit, respectively. The Gₘ gain unit can be kept at the gain value previously set in the phase of tuning G₀ and G₁ (in step q2). The P₂ pulse signal source is used to generate the |0_{d} [symbol] , and the |1_{d} [symbol] decoy states.
Transmitted pattern: pattern 1 from the P₂ pulse signal source.
Procedure: the optical output power/intensity for the merged/combined electric/EM signal is set to substantially equal to

$${I}_{d} = \frac{{μ}_{d}}{μ} \cdot {I}_{p a t tern 1}$$

(wherein μ and μ_{d} are defined by the user, and Iₚₐₜₜₑᵣₙ₁ is the optical output power/intensity measured and recorded in step q2), by scanning gain test values for the gain unit G₂ starting from the predefine permissible minimal gain value G₂ₘᵢₙ and up to the predefine permissible maximal gain value G₂ₘₐₓ.

### Pseudo Code:

For G₂ = G₂ₘᵢₙ to G₂ₘₐₓ
MeasurePower(Iⱼ)
End
G₂ = Gⱼ(Iⱼ == I_{d})

Result: the gain value of the G₂ gain unit is set such that the |0_{d} [symbol] and |1_{d} [symbol] decoy states have optical power/intensity of about

$$\frac{{μ}_{d}}{μ} \cdot {I}_{p a t tern 1} .$$

Optionally, but in some embodiments preferably, the calibration sequence 51 further comprises a self-calibration procedure (step q7) for fine tuning the D₂ delay unit. In order for the decoy states to be indistinguishable from the main quantum states, their timings should be substantially the same. This is obtained in some embodiments by first tuning the pulse signals from the P₂ pulse signal source to overlap with the pulse signals from the P₁ and the P₀ pulse signal sources (which are already overlapping at this stage).
Pattern: pattern 2 from the P₁ pulse signal source and pattern 1 from the P₂ pulse signal source.
Procedure: The procedure for setting the delay time values of the D₂ delay unit is substantially similar to the procedure used for setting the D₀ (or D₁) delay unit (step q4). A test value for the D₂ delay unit is scanned starting from the predefine permissible minimal delay value D₂ₘᵢₙ and up to the predefine permissible maximal gain value D₂ₘₐₓ, and the optical output power/intensity is measured. The delay time value of the D₂ delay unit is set such that the measured optical output power/intensity is minimal.
Result: the delay time value for the D₂ delay unit is set such that the pulse signals from the P₂ pulse signal source overlap with the pulse signals form the P₁ and P₀ pulse signal sources.

Optionally, but in some embodiments preferably, the calibration sequence 51 further comprises a self-calibration procedure (step q8) for initial setting a gain values for the G₃ gain unit. The pulse signal source P₃ has in some embodiments a similar role as that of the P₁ pulse signal source, but for the decoy states, and setting its gain value can thus be similar to the initial setting of the gain value of the G₁ gain unit (step q3), or to the fine tuning of the gain value of the G₁ gain unit (step q5).
Transmitted pattern: pattern 2 from the P₃ pulse signal source.
Procedure: Record (and keep for later use) the optical output power/intensity obtained for a range of test values for the G₃ gain unit, starting from a predefined permissible minimal gain value G₃ₘᵢₙ and up to a predefined permissible maximal gain value G₃ₘₐₓ. The initial gain value for the G₃ gain unit is set such that the peak optical output power/intensity of the pulse is about β·I_{d} e.g., about ½ (half) of optical output power/intensity of the pulses transmitted from the P₂ pulse signal source (I_{pattern2d} recorded in step q3). The parameter β is selected in some embodiments such that the value for which the average optical output power/intensity obtained for the pattern 2 from the P₃ pulse signal source is about ½ (half) the optical output power/intensity obtained for the pattern 1 from the P₂ pulse signal source i.e., β=½. Assuming that the G₂ gain unit is not saturated, the G₃ gain unit is also expected to be unsaturated, as it is a similar component tuned to a lower gain. If this is not a valid assumption, saturation test for the G₃ gain unit is required, and the gain can be set to keep the ratio of optical output power/intensity, while no signal is saturated.

### Pseudo Code:

For G₃ = G₃ₘᵢₙ to G₃ₘₐₓ
MeasurePower(I_{pattern2dj})
End
G₃ ← G₃ⱼ(I_{pattern2dj} == I_{d}/2)

Result: the initial gain values of the G₃ gain unit is set, and the initial gain value for the G₃ gain unit and the measured optical output power/intensity I_{pattern2d} (vector of all gain range) values are recorded.

The predefined permissible minimal and maximal gain values, G₃ₘᵢₙ and G₃ₘₐₓ can be determined by choosing a suitable linear operation regime e.g., according to manufacturer's datasheet.

Optionally, but in some embodiments preferably, the calibration sequence 51 further comprises a self-calibration procedure (step q9) for setting the pulse overlap parameters for the D₃ delay unit. This procedure is configured to set the delay value parameter of the D₃ delay unit such that the pulse signals from the P₃ pulse signal source overlap in the analog combiner Σ₀ with the pulse signals from the P₀, P₁ and P₂, pulse signal sources.
Transmitted pattern: pattern 1 from the P₂ pulse signal source and pattern 2 from the P₃ pulse signal source, which are combined to form pattern 3 when overlapping.
Procedure: When the overlap is acceptable or ideal, the electric pulse power (RMS) is minimal, and the measured optical output power/intensity is minimal as well. This procedure scans the pulse position i.e., delay time values for the D₃ delay unit starting from a predefined permissible minimal delay time value D₃ₘᵢₙ and up to a predefine permissible delay time value D₃ₘₐₓ, to get an optimal overlap.

### Pseudo Code:

```
Iₘᵢₙ = MeasurePower(Iⱼ) //initialization
For D₃ = D₃ₘᵢₙ to D₃ₘₐₓ
  MeasurePower(Iⱼ)
  If Iₘᵢₙ>Iⱼ
    Iₘᵢₙ ← Iⱼ
  End
End
D₃ = D₃ⱼ(Iⱼ == Iₘᵢₙ)
```

Result: the delay time value of the D₃ delay unit is set such that the optical output power/intensity is minimal, such that all electric/EM pulse signal channels overlap.

The predefined permissible minimal and maximal delay time values, D₃ₘᵢₙ and D₃ₘₐₓ can be determined by the range of possible time delay between the pulse sources e.g., as estimated by the system design.

Optionally, but in some embodiments preferably, the calibration sequence 50 further comprises a self-calibration procedure (step q10) for fine tuning the G₃ gain unit. Differences in response of the electro optical chain (e.g., amplifier gain and/or EOM response to different polarities) and/or other non-linearities may lead to different pulse power/intensities for the two optical half-pulses forming the |m_{d} [symbol] decoy state. In order to obtain high visibility interference between the first and second optical half-pulses, it is required to fine tune the gain value of the G₃ gain unit.
Transmitted pattern: pattern 1 from the P₂ pulse signal source and pattern 2 from the P₃ pulse signal source, which are combined to form the pattern 3.
Procedure: the optical output power/intensity for the merged/combined electric/EM pulse signals is set to substantially equal to the optical output power/intensity obtained for pattern 2 generated only by the P₃ pulse signal source (as measured in step q8 as I_{pattern2d}) by scanning test values for the G₃ gain unit starting from the predefined permissible minimal gain value G₃ₘᵢₙ and up to the predefined permissible maximal gain value G₃ₘₐₓ.

### Pseudo Code:

```
For G₃ = G₃ₘᵢₙ to G₃ₘₐₓ
    MeasurePower(Iⱼ)
End
G₃ = G₃ᵢ(Iₕ == I_{pattern2d})
  I_{pattern3d} ← Iⱼ
```

Result: the gain value of the G₃ gain unit is set to provide high visibility for the optical output power/intensity of the |m_{d} [symbol] decoy state, with substantially the same optical output power/intensity as that obtained for the |p_{d} [symbol] decoy state, the gain value for the G₃ gain unit and the measured optical output power/intensity I_{pattern3d} value are recorded.

Optionally, but in some embodiments preferably, the calibration sequence 50 and/or 51 further comprises a self-calibration procedure for setting direct modulation of the light source signal delay and/or duty cycle. In some embodiments all prior settings of the pulse signals and optical output power/intensity measurements are conducted while the light source 12 is in a continuous-wave (CW) operation mode. However, in QKD systems, as a countermeasure for coherent phase attacks, the phase between qubits needs to be randomized. One way to randomize the phase is to directly modulate the electric supply current of the (e.g., laser) light source 12.

Direct modulation of the laser light source 12 is performed in some embodiments by changing its electric driving current from the current source 11 to different levels e.g., the electric supply current level I_{work} in which the laser is “ON” and an electric supply current level I_{rnd} for which the phase of the (e.g., laser) light signal output is randomized, where I_{rnd} can be lower than the laser operating (lasing) threshold current. The goal of this calibration procedure is to position the optical output pulses produce by the EOM 13 within the stable power regime of the “ON” time of the laser light source 12. This can ensure that equal optical pulse amplitudes are obtained in time t₀ and t₁, (as exemplified in FIG. 2).

Another advantage of the direct modulation of the electric supply current of the light source 12 is that it can improve the contrast of the optical output signal and the system's signal to noise ratio (SNR), so there is advantage to keep the “ON” time to a minimal duration (minimal duty cycle).

In some embodiments the “ON” time is set from three parts: (i) the rise time, wherein the optical output power/intensity obtained for the electrical/EM pulse signal pattern 5 is lower than that obtained for the electrical/EM pulse signal pattern 6; (ii) the stable regime of the “ON” time, wherein the optical output powers/intensities obtained for pattern 5 and pattern 6 are equal; and (iii) the fall time in which the optical output power/intensity obtained for pattern 5 is higher than that obtained for pattern 6.
Transmitted pattern: pattern 5 from the P₀ pulse signal source, and thereafter pattern 6 also from the P₀ pulse signal source. The repetition rate of the laser direct modulation is the same as that of the pattern 5 and pattern 6 repetition electric/EM pulse signal rates, such that each I_{work} regime (“ON” time) of the laser light source 12 should contain an optical output pulse that is responsive to a respective electric/EM pulse signal pattern.
Procedure: When the position of the electric/EM pulse signals in the direct modulation “ON” time is acceptable or ideal, the optical output power responsive to the pattern 5 and pattern 6 electric/EM pulse signals is substantially equal. The laser driver direct modulation timing can be scanned by changing the delay time value of the D_{LD} delay unit i.e., the delay of the light signal modulation relative to the pulse signals, starting from a predefined permissible minimal delay time value D_{LDmin} and up to a predefine permissible delay time value D_{LDmax}, to get an optimal setting for the pattern 5 electric/EM pulse signal and then for the pattern 6 electric/EM pulse signal.
The minimal time duration of the “ON” time interval can be set according to the measurement of the optical output pulse signals by the power meter unit 16. The initial time duration of the “ON” time internal T_{LD0} is determined first, which is >>t₁−t₀. Thereafter, the excess time T_{LDexcess}, in which the optical output power/intensity of the pattern 5 and pattern 6 electric/EM pulse signals is substantially equal, is determined. T_{LDexcess} is reduced from the initial duration time T_{LD0} in order to obtain the minimal value T_{LDmin}. The delay time position is redefined in order to set the optical pulses in the new minimal “ON” time location.

### Pseudo Code:

```
Pattern 5
For D_{LD,j} = D_{LDmin} to D_{LDmax}
  MeasurePower(I_{rnd,j})
End
Pattern 6
For D_{LD,j} = D_{LDmin} to D_{LDmax}
  MeasurePower(I_{1,j})
End
D_{LD} = D_{LD,j}((I_{pattern5,j} == I_{pattern6,j}) && (I_{pattern5,j+1}> I_{pattern6,j+1})) //the second term
means that for delay D_{LD,j+1} the pulse from pattern6 is at the fall time of the laser
modulation
T_{LD0} = D_{LD,j}(I_{pattern5,j}> I_{pattern6,j}) && ( I_{pattern6,j+1}==0) − D_{LD,j} (I_{pattern5,j} < I_{pattern6,j}) )
&& ( I_{pattern6,j+1}==0))
T_{LDexcess} = D_{LD,j}((I_{pattern5,j} == I_{pattern6,j}) && (I_{pattern5,j+1}> I_{pattern6,j+1})) −
D_{LD,j}((I_{pattern5,j} == I_{pattern6,j}) && (I_{pattern5,j-1} < I_{pattern6,j-1}))
T_{LDmin}= T_{LD0} − T_{LDexcess}
D_{LD} = D_{LD,i}((I_{pattern5,i} == I_{pattern6,i}) && (I_{pattern5,i+1}> I_{pattern6,i+1})) + T_{LDexcess}
```

Result: the delay time value for the D_{LD} delay unit is set such that the optical pulses are substantially at the same output power/intensity of the directly modulated laser light source 12, and the “ON” time is minimized.

The predefined permissible minimal and maximal delay time values, D_{LDmin} and D_{LDmax}, can be determined by the period time (set by the repetition rate) of the pattern 5 and pattern 6 signals.

Optionally, but in some embodiments preferably, the calibration sequence 50 and/or 51 further comprises a self-calibration procedure for setting gain value for the VOA unit 14 for required single photon amplitude μ. This procedure requires factory calibration value of a few passive components of the transmitter system 10/10′. A QKD system according to some possible embodiments may employ a weak coherent pulse (WCP) from a modulated laser light source 12 as the photon source. In such embodiments it is important that the mean photon number of the quantum states μ is determined precisely and monitored continuously. A possible way to achieve a WCP is by attenuating the coherent light generated by light source 12 such that the output to the QKD channel (i.e., the QC) will have values of μ<1. However, variations e.g., due to thermal instability or other factors, may vary the value of μ, making the system vulnerable to attacks or reduce the system efficiency.

Accordingly, it is essential to keep the value of μ constant and monitored. This requires factory calibration value of a few passive components (e.g., fixed attenuators, and/or optical splitters and every other optical element on the optical path) in addition to an active automated monitor and correction actions.
Transmitted pattern: pattern 5 from the P₀ pulse signal source during the calibration process, and random states (main and decoy) with a known distribution and measured power (power measurement of every state was done in previous stages) during the continuous operation of the system.
Procedure: Factory calibration of the attenuation and splitting ratios of the optical path after the VOA is required (including temperature dependence if exists) e.g., of the fixed attenuator 17. The attenuation value of the VOA 14 is set to a minimum attenuation. For this stage only, the photodiode of the power meter 16 needs to be calibrated. This procedure measures the optical output power/intensity I_{PD} measured by the calibrated internal photodiode or power meter 16. The optical output signal I_{μ} i.e., the power/intensity measured for the desired μ, is calculated from all relevant system parameters, for example μ, μ_{d}, wavelength, background noise level, repetition rate, decoy protocol parameters, fixed attenuators, splitting ratio etc. In possible embodiments the attenuation value of the VOA 14 is set such that I_{PD}=I_{μ} e.g., by using single-photon avalanche diode (SPAD) in the power meter 16.

### Pseudo Code:

```
Pattern 5 or all states
loop
  MeasurePower(I_{PD})
  Set VOA(I_{PD} · FixedAttenuation == I_{μ})
End
```

(FixedAttenuation is the attenuation resulting from all components with a fixed attenuation, including attenuators, splitters, isolators, splices etc.)
Result: the attenuation value of the VOA 14 is adjusted such that μ, μ_{d} are set to the desired target value.

Optionally, but in some embodiments preferably, the calibration sequence 50 and/or 51 further comprises a self-calibration procedure for estimating the crosstalk of the |0 [symbol] and |1 [symbol] main quantum states. In the QKD protocol every signal that is measured in the wrong state is represented by the quantum bit error rate (QBER) and regarded as it may arise from an eavesdropper. To overcome this, the total QBER of the system is taken into account and the maximal possible system secure key rate is calculated accordingly. One possible contribution to this noise is crosstalk caused by non-ideal pulse generation. Specifically, what is the magnitude of the photon leakage from the |0 [symbol] main quantum state into the time slot of the |1 [symbol] main quantum state.
Transmitted pattern: pattern 5 from the P₀ pulse signal source and pattern 1 from the P₀ pulse signal source.
Procedure: For pattern 5 from the P₀ pulse signal source measure the optical output power/intensity. Then measure the optical output power/intensity for the pattern 1 from the P₀ pulse signal source. After subtracting the optical vacuum power/intensity, the Pattern 1 electric/EM pulse signal should produce about twice the optical output power/intensity produced by the pattern 5 electric/EM pulse signal (2 pulses compared to 1). If there is however a difference, it is the crosstalk that is translated to the QBER, as the modulator optical output is non-linear with respect to the electrical input.

### Pseudo Code:

MeasurePower(I_{0,Vacuum})
Pattern 5
MeasurePower(I₀,5)
Pattern 1
MeasurePower(I₀,1)
Crosstalk= I_{0,1=} 2·I_{0,5=}I_{0,vacuum}

Result: Crosstalk is measured and used as parameter for maximal possible secure rate.

Measures to reduce the crosstalk, such as pre-emphasis configurations can be applied accordingly.

Optionally, but in some embodiments preferably, the calibration sequence 50 and/or 51 further comprises a self-calibration procedure for summarizing all of the tests/calibration procedures (Alice benchmarking and parameter estimation). As a final step the intrinsic QBER of Alice is calculated. This allows benchmarking of the QKD transmitter systems 10/10′ without the need for a QKD Bob receiver system 19. This can assist in pairing Alice and Bob systems' for specific performance requirements. In addition, it can also help recognizing malfunctions and degradation in the transmitter quality. These parameters can also assist in precise determination of the decoy state parameters. This is achieved in some embodiments by crosstalk estimation, based on differences in the optical output power/intensity measured for the |p [symbol] and |m [symbol] main quantum states, which affects the QBER directly

Using the testing/calibration procedures disclosed herein, nearly arbitrary electric and optical signals can be generated with standard FPGA and electronics, and versatile programmable pulse generators can be implemented at relatively low costs. Nowadays electric/EM signal generators capable of generating 100 ps pulses may cost over 100,000 USD, and this solution can be built for less than 2000 USD.

It should also be understood that throughout this disclosure, where a process or method is shown or described, the steps/acts of the method may be performed in any order and/or simultaneously, and/or with other steps/acts not-illustrated/described herein, unless it is clear from the context that one step depends on another being performed first. In possible embodiments not all of the illustrated/described steps/acts are required to carry out the method.

Functions of the system described hereinabove may be controlled through instructions executed by a computer-based control system 18/18′. The control system 18/18′ suitable for use with embodiments described hereinabove may include, for example, one or more processors connected to a communication bus, one or more volatile memories (e.g., random access memory—RAM) or non-volatile memories (e.g., Flash memory). A secondary memory (e.g., a hard disk drive, a removable storage drive, and/or removable memory chip such as an EPROM, PROM or Flash memory) may be used for storing data, computer programs or other instructions, to be loaded into the computer system.

The flowcharts and block diagrams in the different depicted embodiments may represent a module, segment, function, and/or a portion of an operation or step. For example, one or more of the blocks may be implemented as program code, in hardware, or as a combination of the two. Items, such as the various illustrative blocks, modules, elements, components, methods, operations, steps, and algorithms described herein may be implemented as hardware or a combination of hardware and computer software. Whether such functionality is implemented as hardware or software depends upon the particular application and design constraints imposed on the overall system. Skilled artisans may implement the described functionality in varying ways for each particular application.

In an embodiment where the features of the disclosed embodiments are implemented by software, the software can be stored in a computer program product and loaded into the computer system using the removable storage drive, the memory chips or the communications interface. The control logic (software), when executed by a control processor, causes the control processor to perform certain functions of the presently presented subject matter as described herein. In another embodiment, features of the presently presented subject matter are implemented primarily in hardware using, for example, hardware components such as application specific integrated circuits (ASICs) or field-programmable gated arrays (FPGAs). Implementation of the hardware state machine so as to perform the functions described herein will be apparent to persons skilled in the relevant art(s). In yet another embodiment, features of the presently presented subject matter can be implemented using a combination of both hardware and software.

As described hereinabove and shown in the associated figures, the present application provides transmitter systems for QKD applications and related methods. While particular embodiments of the presently presented subject matter have been described, it will be understood, however, that the presently presented subject matter is not limited thereto, since modifications may be made by those skilled in the art, particularly in light of the foregoing teachings. As will be appreciated by the skilled person, the presently presented subject matter can be carried out in a great variety of ways, employing more than one technique from those described above, all without exceeding the scope of the claims.

1. A QKD transmitter system comprising:
a plurality of pulse signal sources, at least one of which configured to generate pulse signals which voltage polarity is opposite to a voltage polarity of pulse signals of at least another one of said plurality of signal pulse sources;
a plurality of signal manipulating units, each configured to controllably adjust at least one of amplitude and delay time of at least some of the pulse signals generated by said plurality of pulse signal sources; and
a plurality of analog combiner units configured to combine the adjusted and non-adjusted pulse signals and generate therefrom a light-modulating signal that is substantially proportional to a summation of the adjusted and non-adjusted pulse signals, for modulating quantum communication states in light generated by a light source.

2. (canceled)

3. The QKD transmitter of claim 1 comprising an output tuneable gain unit configured to controllably adjust the light-modulating signal before modulating the quantum communication states.

4. The QKD transmitter of claim 3 comprising three pulse signal sources, respective three signal manipulating units, and two analog combiner units.

5. The QKD transmitter of claim 4 configured such that the pulse signals generated by the pulse signal source configured to generate the pulse signals with the opposite voltage polarity are not combined with pulse signals from the other pulse signal sources for generation of at least one main quantum state of the quantum communication states.

6. The QKD transmitter of claim 4 configured either such that:
a first analog combiner (Σ₁) of the two analog combiners is configured to combine pulse signals generated by second and third pulse signal sources (P₁ P₂) of the three pulse signal sources having opposite voltage polarities, and a second analog combiner (Σ₀) of said two analog combiners is configured to combine signals produced by said first analog combiner (Σ₁) with pulse signals generated by a first pulse signal source (P₀) of the three pulse signal sources; or
single analog combiner is configured to combine the first, second and third, pulse signal sources (P₀, P₁ and P₂).

7. (canceled)

8. The QKD transmitter of claim 6 configured for at least one of the following:
cause the respective signal manipulating unit of the first pulse signal source (P₀) and the output tuneable gain unit (Gₘ) to adjust amplitudes of signals thereby received such that power/intensity I of the modulated light responsive to pulse signals generated by the first pulse signal source (P₀) is attenuated by a predefined upper-level intensity setting factor α to about α·I, wherein 0.95≤α<1;
cause the respective signal manipulating unit of the second pulse signal source (P₁) to adjust amplitudes of signals thereby received such that power/intensity of the modulated light I responsive to pulse signals generated by the first pulse signal source (P₀) is attenuated by a predefined mid-intensity level setting factor β to about β·I, wherein β<α;
cause the respective signal manipulating unit of the first pulse signal source (P₀) to adjust amplitude of signals thereby received such that power/intensity of the modulated light I responsive to pulse signals generated by the first and second pulse signal sources (P₀ and P₁) is attenuated by an upper-mid-level intensity setting factor γ to an upper-mid-level power/intensity I_{β}, wherein β<γ<α;
cause the respective signal manipulating unit of the third pulse signal source (P₂) to adjust amplitude of signals thereby received such that power/intensity of the modulated light I responsive to pulse signals generated by the first, second and third, pulse signal sources (P₀, P₁ and P₂) is attenuated to the upper-mid-level power/intensity I_{β};
cause the respective signal manipulating unit of the third pulse signal source (P₂) to adjust amplitude of signals thereby received such that power/intensity of the modulated light I responsive to pulse signals generated by the second and third pulse signal sources (P₁ and P₂) is attenuated to about half of the upper-mid-level power/intensity I_{β}.

9. (canceled)

10. (canceled)

11. (canceled)

12. (canceled)

13. The QKD transmitter of claim 6 configured to cause at least one of the following: the respective signal manipulating unit of the first and/or second pulse signal sources (P₀ and/or P₁) to adjust time delay of signals thereby received such that power/intensity of the modulated light I responsive to pulse signals generated by said first and second pulse signal sources is minimized; the respective signal manipulating unit of the third pulse signal source (P₂) to adjust time delay of signals thereby received such that power/intensity of the modulated light I responsive to pulse signals generated by the second and third pulse signal sources is minimized.

14. (canceled)

15. The QKD transmitter of claim 1 comprising two pairs of the pulse signal sources, respective four signal manipulating units each coupled to one of said pulse signal sources, and three analog combiner units, wherein the pulse signal sources of each pair of the pulse signal sources are configured to generate pulse signals of opposite voltage polarities, wherein one pair of the pulse signals sources is configured to generate main quantum states of the quantum communication states, and the other pair of the pulse signals sources is configured to generate decoy states of said quantum communication states.

16. (canceled)

17. The QKD transmitter of claim 15 configured for at least one of the following:
a first analog combiner (Σ₂) of the three analog combiners is configured to combine pulse signals generated by fourth and third pulse signal sources (P₃ and P₂) forming one of the pairs of the pulse signal sources, a second analog combiner (Σ₁) of said three analog combiners is configured to combine signals produced by said first analog combiner (Σ₂) with pulse signals generated by a second pulse signal source (P₁) of the four pulse signal sources, and a third analog combiner (Σ₀) of said three analog combiners is configured to combine signals produced by said second analog combiner (Σ₁) with pulse signals generated by a first pulse signal source (P₀) of the four pulse signal sources, said first and second pulse signal sources (P₀ and P₀) are forming the other pair of pulse signal sources;
a single analog combiner is configured to combine the first, second, third and fourth, pulse signal sources (P₀, P₁, P₂ and P₃);
cause the respective signal manipulating unit of the first pulse signal source (P₀) and the output tuneable gain unit (Gₘ) to adjust amplitudes of signals thereby received such that power/intensity I responsive to pulse signals generated by the first pulse signal source (P₀) of the modulated light is attenuated by a predefined upper-level intensity setting factor α to an upper-level power/intensity Iₚₐₜₑᵣₙ₁=α·I, wherein 0.95≤α<1;
cause the respective signal manipulating unit of the second pulse signal source (P₁) to adjust amplitudes of signals thereby received such that power/intensity of the modulated light I responsive to pulse signals generated by the second pulse signal source (P₁) is attenuated to a mid-intensity level Iₚₐₜₜₑᵣₙ₂ of about β·Iₚₐₜₜₑᵣₙ₁, wherein β<α is predefined mid-intensity level setting factor,
cause the respective signal manipulating unit of the second pulse signal source (P₁) to adjust amplitudes of signals thereby received such that power/intensity of the modulated light I responsive to pulse signals generated by the first and second pulse signal sources (P₀ and P₁) is attenuated to a fine-tuned-intensity level Iₚₐₜₜₑᵣₙ₃ of about Iₚₐₜₜₑᵣₙ₂;
cause the respective signal manipulating unit of the third pulse signal source (P₂) to adjust amplitudes of signals thereby received such that power/intensity of the modulated light I responsive to pulse signals generated by the third pulse signal source (P₂) is attenuated to about (μ_{d}/μ)·Iₚₐₜₜₑᵣₙ₁, wherein μ and μ_{d} are predefined uniform average number of photons for main and decoy quantum states respectively;
cause the respective signal manipulating unit of the fourth pulse signal source (P₃) to adjust amplitudes of signals thereby received such that power/intensity of the modulated light I responsive to pulse signals generated by the fourth pulse signal source (P₃) is attenuated to a mid-decoy level I_{pattern2d}=β·Iₚₐₜₜₑᵣₙ₁, wherein β<α is predefined mid-intensity level setting factor;
cause the respective signal manipulating unit of the fourth pulse signal source (P₃) to adjust amplitudes of signals thereby received such that power/intensity of the modulated light I responsive to pulse signals generated the third and fourth pulse signal source (P₂ and P₃) is attenuated to the mid-decoy level I_{pattern2d};
cause the respective signal manipulating unit of the first and/or second pulse signal sources (P₀ and/or P₁) to adjust time delay of signals thereby received such that power/intensity of the modulated light I responsive to pulse signals generated by the first and second pulse signal sources is minimized;
cause the respective signal manipulating unit of the third pulse signal sources (P₂) to adjust time delay of signals thereby received such that power/intensity of the modulated light I responsive to pulse signals generated by the second and third pulse signal sources (P₁ and P₂) is minimized;
cause the respective signal manipulating unit of the fourth pulse signal sources (P₃) to adjust time delay of signals thereby received such that power/intensity of the modulated light I responsive to pulse signals generated by the third and fourth pulse signal sources (P₂ and P₃) is minimized.

18. (canceled)

19. (canceled)

20. (canceled)

21. (canceled)

22. (canceled)

23. (canceled)

24. (canceled)

25. (canceled)

26. (canceled)

27. (canceled)

28. The QKD transmitter of claim 1 wherein the quantum communication states comprise four main quantum states, four decoy states, and one vacuum state.

29. The QKD transmitter of claim 4 wherein the quantum communication states comprise four main quantum states, any number of decoy states, and one vacuum state.

30. The QKD transmitter of claim 1 comprising a power meter configured to measure optical output power/intensity of the modulated light signals and generate measurement data/signals indicative thereof, and a control unit configured and operable to adjust at least one of the plurality of signal manipulating units and/or the output tuneable gain unit based on said measurement data/signals.

31. (canceled)

32. The system of claim 1 configured to receive feedback data/signals indicative of interference visibility obtained in response to transmitted optical signals, and wherein the control unit is configured adjust at least one of a frequency of a clock unit thereof and pulse time difference of the pulse signals based on said feedback data/signals.

33. A method for calibration of a QKD transmitter, the method comprising: generating a plurality of pulse signals, voltage polarity of at least one of said plurality of pulse signals is opposite to a voltage polarity of at least another one of said plurality of pulse signals; combining said plurality of pulse signals and generating therefrom a light-modulating signal; modulating light signal by said light-modulating signal; measuring said modulated light signals and generating measurement data indicative thereof, and adjusting at least one of amplitude and delay time of at least some of said plurality of pulse signals to obtain a desired quantum communication state.

34. The method of claim 33 comprising combining first, second and third, pulse signals to generate the light-modulating signal, wherein said second pulse signal (P₁) having the opposite voltage polarity and generating at least one main quantum state by the pulse signal source configured to generate the pulse signals with the opposite voltage polarity without combining it with the other pulse signals.

35. (canceled)

36. The method of claim 34 comprising at least one of the following:
adjusting amplitudes of the first pulse signal and of the light-modulating signal such that power/intensity I of the modulated light signals responsive to said first pulse signal is attenuated by a predefined upper-level intensity setting factor α to about α·I, wherein 0.95≤α<1
adjusting amplitude of the second pulse signal (P₁) such that power/intensity of the modulated light signals I responsive to the first pulse signal (P₀) is attenuated by a predefined mid-intensity level setting factor β to about β·I, wherein β<α;
adjusting the first pulse signal (P₀) such that power/intensity of the modulated light signals I responsive to the first and second pulse signals (P₀ and P₁) is attenuated by an upper-mid-level intensity setting factor γ to an upper-mid-level power/intensity I_{β}, wherein β<γ<α;
adjusting amplitude of the third pulse signal (P₂) such that power/intensity of the modulated light signals I responsive to the first, second and third, pulse signals (P₀, P₁ and P₂) is attenuated to the upper-mid-level power/intensity I_{β};
adjusting amplitudes of the third pulse signal (P₂) such that power/intensity of the modulated light signals I responsive to the second and third pulse signals (P₁ and P₂) is attenuated to about half of the upper-mid-level power/intensity I_{β};
adjusting time delay of the first and/or second pulse signals (P₀ and/or P₁) such that power/intensity of the modulated light signals I responsive to said first and second pulse signals is minimized;
adjusting time delay of the third pulse signal source (P₂) such that power/intensity of the modulated light signals I responsive to the second and third pulse signals is minimized.

37. (canceled)

38. (canceled)

39. (canceled)

40. (canceled)

41. (canceled)

42. (canceled)

43. The method of claim 33 comprising generating the light modulating signal by combining two pairs of the pulse signals, wherein each of said pairs pulse signals are of opposite voltage polarities.

44. The method of claim 43 comprising generating main quantum states from one pair of the pulse signals, and generating decoy states from the other pair pulse signals.

45. The method of claim 43 comprising at least one of the following:
adjusting amplitudes of the first pulse signal (P₀) and of the light-modulating of signals such that power/intensity of the modulated light signals I responsive to the first pulse signal (P₀) is attenuated by a predefined upper-level intensity setting factor α to an upper-level power/intensity Iₚₐₜₜₑᵣₙ₁=α·I, wherein 0.95≤α<1;
adjusting amplitude of the second pulse signal (P₁) such that power/intensity of the modulated light signal I responsive to the second pulse signal (P₁) is attenuated to a mid-intensity level Iₚₐₜₜₑᵣₙ₂ of about β·Iₚₐₜₜₑᵣₙ₁, wherein β<α is predefined mid-intensity level setting factor;
adjusting amplitude of the second pulse signal (P₁) such that power/intensity of the modulated light signals I responsive to the first and second pulse signal (P₀ and P₁) is attenuated to a fine-tuned-intensity level Iₚₐₜₜₑᵣₙ₃ of about Iₚₐₜₜₑᵣₙ₂;
adjusting amplitude of the third pulse signal (P₂) such that power/intensity of the modulated light signals I responsive to the third pulse signal (P₂) is attenuated to about μ_{d}/μ·Iₚₐₜₜₑᵣₙ₁, wherein μ and μ_{d} are predefined uniform average number of photons for main and decoy quantum states respectively;
adjusting amplitude of the fourth pulse signal (P₃) such that power/intensity of the modulated light signals I responsive to the fourth pulse signal (P₃) is attenuated to a mid-decoy level I_{pattern2d}=β·Iₚₐₜₜₑᵣₙ₁, wherein β<α is predefined mid-intensity level setting factor;
adjusting amplitude of the fourth pulse signal (P₃) such that power/intensity of the modulated light signal I responsive to the third and fourth pulse signal (P₂ and P₃) is attenuated to the mid-decoy level I_{pattern2d};
adjusting a time delay of the first and/or second pulse signal (P₀ and/or P₁) such that power/intensity of the modulated light signals I responsive to said first and second pulse signal is minimized;
adjusting time delay of the third pulse signal (P₂) such that power/intensity of the modulated light signals I responsive to the second and third pulse signal (P₁ and P₂) is minimized;
adjusting a time delay of the fourth pulse signal (P₃) such that power/intensity of the modulated light signals I responsive to the third and fourth pulse signal (P₂ and P₃) is minimized.

46. (canceled)

47. (canceled)

48. (canceled)

49. (canceled)

50. (canceled)

51. (canceled)

52. (canceled)

53. (canceled)

54. The method of claim 33 comprising receiving feedback data/signals indicative of interference obtained in response to transmitted optical signals, and adjusting at least one of a frequency of a clock unit of the transmitter and pulse time difference of the pulse signals based on said feedback data/signals.
